(19) United States
(12) Patent Application Publication
(10) Pub. No.: US 2010/0264772 A1
(43) Pub. Date: Oct. 21, 2010

(54) DIRECT CURRENT MOTOR

(75) Inventors: Tomohiro AOYAMA, Kosai-shi (JP); Kuniaki MATSUMOTO, Kosai-shi (JP); Toshio YAMAMOTO, Kosai-shi (JP)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: ASMO CO., LTD., Kosai-shi (JP)

(21) Appl. No.: 12/761,935

(22) Filed: Apr. 16, 2010

(30) Foreign Application Priority Data
Apr. 21, 2009 (JP) 2009-103207
Apr. 7, 2010 (JP) 2010-088774

(51) Int. Cl. H02K 3/28

(52) U.S. Cl. 310/195

(57) ABSTRACT

A direct current motor is provided that includes an armature core, a commutator, coils, positive brushes, and negative brushes. The armature core includes a stator. The stator has magnets the number of which is represented by P (where P is an even number greater than or equal to six). The coils are wound about the teeth by duplex wave winding. Alternatively, the coils are wound about the teeth such that each pair of coils that are spaced apart by 180° are connected common ones of the segments. Each of the positive brushes and the negative brushes has an angular width WB, at which it slides on the segments. When the angular width of the arrangement pitch of the segments is represented by WP (WP=360°/the number of the segments), and the angular width of the clearance between each pair of circumferentially adjacent segments is represented by WU, the angular width WB is set to satisfy the expression: WB≦(4/P)×WP+WU.

### BACKGROUND OF THE INVENTION

The present invention relates to a direct current motor having positive brushes and negative brushes.

Japanese Laid-Open Patent Publication No. 2001-320862 discloses a direct current motor in which coils are wound about teeth of an armature core by duplex wave winding. In a direct current motor in which coils are wound about teeth by single wave winding, that is, in a direct current motor having an odd number of teeth (slots), there is an imbalance between the number of magnetic poles and the number of the teeth. In other words, there is a magnetic imbalance. Such an imbalance can be avoided by the direct current motor of the above publication since it has an even number of teeth (slots). Accordingly, vibration and noise are reduced.

In the conventional direct current motor described above, each of the positive brushes and the negative brushes has an angular width that is greater than that of a single segment so that each brush can overlap with three segments in a commutator. More specifically, the angular width of each of the positive brushes and the negative brushes is greater than the sum of the angular width of each segment and an angular width equivalent to double the clearance between an adjacent pair of the segments. For example, a case will be considered in which a direct current motor has a stator with six magnetic poles and an armature core with twenty-two teeth, and coils are wound about the teeth by duplex wave winding. In this direct current motor, if the angular width of the positive brushes and the negative brushes is set twice the angular width of each segment, current pulsation occurs once while the armature core and the commutator rotate by an amount equivalent to the arrangement pitch of the segments (twenty-two times per rotation of the armature core). Also, the number of short-circuited coils is changed between six numbers during a rotation by a single pitch. That is, while the armature core rotates once, the number of the short circuited coils switches between six and zero, twenty-two times. This increases the torque pulsation and generates large vibration and noise.

### SUMMARY OF THE INVENTION

Accordingly, it is an objective of the present invention to provide a direct current motor that reduces vibration and noise.

To achieve the foregoing objective and in accordance with a first aspect of the present invention, a direct current motor is provided that includes a stator, an armature core, a commutator, coils, positive brushes, and negative brushes. The stator includes a yoke and magnetic poles arranged along the circumferential direction of the yoke. The number of the magnetic poles is represented by P (where P is an even number greater than or equal to six). The armature core is provided to be rotatable relative to the stator. The armature core includes teeth arranged along the circumferential direction. The number of the teeth is represented by an expression n×P±2 (where n is a natural number). The commutator is rotatable integrally with the armature core. The commutator includes segments the number of which is equal to the number of the teeth. The coils are wound about the teeth by duplex wave winding. Alternatively, the coils are wound about the teeth such that current is supplied to the coils at the same timing as the timing at which current is supplied to the coils that are wound by duplex wave winding. The positive brushes and the negative brushes are held by the stator. The positive brushes and the negative brushes are pressed against the segments. The number of the positive brushes and the number of the negative brushes are both represented by P/2. The positive brushes and the negative brushes are alternately arranged at equal angular intervals. Each of the positive brushes and the negative brushes has an angular width WB, at which it slides on the segments. When the angular width of the arrangement pitch of the segments is represented by WP (WP=360°/the number of the segments), and the angular width of the clearance between each pair of circumferentially adjacent segments is represented by WU, the angular width WB is set to satisfy the expression: WB≦(4/P)×WP+WU.

In accordance with a second aspect of the present invention, a direct current motor is provided that includes a stator, an armature core, a commutator, coils, positive brushes, and negative brushes. The stator includes a yoke and magnetic poles arranged along the circumferential direction of the yoke. The number of the magnetic poles is represented by P (where P is an even number greater than or equal to six). The armature core is provided to be rotatable relative to the stator. The armature core includes teeth arranged along the circumferential direction. The number of the teeth is represented by an expression n×P±2 (where n is a natural number). The commutator is rotatable integrally with the armature core. The commutator includes segments the number of which is equal to the number of the teeth. The coils are wound about the teeth by duplex wave winding. Alternatively, the coils are wound about the teeth such that current is supplied to the coils at the same timing as the timing at which current is supplied to the coils that are wound by duplex wave winding. The positive brushes and the negative brushes are held by the stator. The positive brushes and the negative brushes are pressed against the segments. The number of the positive brushes and the number of the negative brushes are both represented by P/2. The positive brushes and the negative brushes are alternately arranged at equal angular intervals. Each of the positive brushes and the negative brushes has an angular width WB, at which it slides on the segments. When the angular width of the arrangement pitch of the segments is represented by WP (WP=360°/the number of the segments), and the angular width of the clearance between each pair of circumferentially adjacent segments is represented by WU, the angular width WB is set to satisfy the expression: WB≦(2/P)×WP+WU.

In accordance with a third aspect of the present invention, a direct current motor is provided that includes a stator, an armature core, a commutator, coils, positive brushes, and negative brushes. The stator includes a yoke and six magnetic poles arranged along the circumferential direction of the yoke. The armature core is provided to be rotatable relative to the stator. The armature core includes teeth arranged along the circumferential direction. The number of the teeth is represented by an expression 3×N±1 (where N is an odd number greater than or equal to three). The commutator is rotatable integrally with the armature core. The commutator includes segments the number of which is equal to the number of the teeth. The coils are wound about the teeth by duplex wave winding. Alternatively, the coils are wound about the teeth such that current is supplied to the coils at the same timing as the timing at which current is supplied to the coils that are wound by duplex wave winding. The positive brushes and the negative brushes are held by the stator. The positive brushes and the negative brushes are pressed against the segments. The number of the positive brushes and the number of the negative brushes are both three. The positive brushes and the negative brushes are arranged at equal angular intervals. Each of the positive brushes and the negative brushes has an angular width WB, at which it slides on the segments. When the angular width of the arrangement pitch of the segments is represented by WP (WP=360°/the number of the segments), and the angular width of the clearance between each pair of circumferentially adjacent segments is represented by WU, the angular width WB is set to satisfy the expression: WB=(2/3)×WP+WU.

In accordance with a fourth aspect of the present invention, a direct current motor is provided that includes a stator, an armature core, a commutator, coils, positive brushes, and negative brushes. The stator includes a yoke and six magnetic poles arranged along the circumferential direction of the yoke. The armature core is provided to be rotatable relative to the stator. The armature core includes teeth arranged along the circumferential direction. The number of the teeth is represented by an expression 3×N±1 (where N is an odd number greater than or equal to three). The commutator is rotatable integrally with the armature core. The commutator includes segments the number of which is equal to the number of the teeth. The coils are wound about the teeth by duplex wave winding. Alternatively, the coils are wound about the teeth such that current is supplied to the coils at the same timing as the timing at which current is supplied to the coils that are wound by duplex wave winding. The positive brushes and the negative brushes are held by the stator. The positive brushes and the negative brushes are pressed against the segments. The number of the positive brushes and the number of the negative brushes are both three. The positive brushes and the negative brushes are arranged at equal angular intervals. Each of the positive brushes and the negative brushes has an angular width WB, at which it slides on the segments. When the angular width of the arrangement pitch of the segments is represented by WP (WP=360°/the number of the segments), and the angular width of the clearance between each pair of circumferentially adjacent segments is represented by WU, the angular width WB is set to satisfy the expression: WB=(1/3)×WP+WU.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a schematic cross-sectional view of a direct current motor according to a first embodiment of the present invention;

FIG. 2A is a waveform chart of current pulsation in a conventional direct current motor;

FIG. 2B is a waveform chart of current pulsation in the direct current motor of FIG. 1;

FIGS. 3A and 3B are diagrammatic developed views illustrating the direct current motor of FIG. 1;

FIGS. 4A and 4B are diagrammatic developed views illustrating the direct current motor of FIG. 1;

FIGS. 5A and 5B are diagrammatic developed views illustrating the direct current motor of FIG. 1;

FIG. 6 is a diagrammatic developed view illustrating the direct current motor of FIG. 1;

FIGS. 7A and 7B are diagrammatic developed views illustrating a direct current motor according to a second embodiment of the present invention;

FIGS. 8A and 8B are diagrammatic developed views illustrating the direct current motor of FIG. 7A;

FIGS. 9A and 9B are diagrammatic developed views illustrating the direct current motor of FIG. 7A;

FIG. 10 is a diagrammatic developed view illustrating the direct current motor of FIG. 7A;

FIGS. 11A and 11B are diagrammatic developed views illustrating a direct current motor according to a third embodiment of the present invention;

FIGS. 12A and 12B are diagrammatic developed views illustrating the direct current motor of FIG. 11A;

FIGS. 13A and 13B are diagrammatic developed views illustrating the direct current motor of FIG. 11A;

FIG. 14 is a diagrammatic developed view illustrating the direct current motor of FIG. 11A;

FIGS. 15A and 15B are diagrammatic developed views illustrating a direct current motor according to a fourth embodiment of the present invention;

FIG. 16 is a diagrammatic developed view illustrating the direct current motor of FIG. 15A;

FIGS. 17A and 17B are diagrammatic developed views illustrating a direct current motor according to a fifth embodiment of the present invention;

FIG. 18 is a diagrammatic developed view illustrating the direct current motor of FIG. 17A;

FIGS. 19A and 19B are diagrammatic developed views illustrating a direct current motor according to a sixth embodiment of the present invention;

FIG. 20 is a diagrammatic developed view illustrating the direct current motor of FIG. 19A;

FIG. 21 is a diagrammatic developed view illustrating a direct current motor according to a seventh embodiment of the present invention;

FIG. 22 is a schematic plan view of the armature of FIG. 21;

FIG. 23 is a diagrammatic developed view illustrating a direct current motor according to an eighth embodiment of the present invention;

FIG. 24 is a schematic plan view of the armature of FIG. 23;

FIG. 25 is a diagrammatic developed view illustrating a direct current motor according to a ninth embodiment of the present invention;

FIG. 26 is a schematic plan view of the armature of FIG. 25;

FIG. 27 is a chart for explaining the number of teeth in relation to the number of magnetic poles in the present invention;

FIGS. 28A and 28B are diagrammatic developed views illustrating a direct current motor according to a tenth embodiment of the present invention; and

FIGS. 29A and 29B are diagrammatic developed views illustrating a direct current motor according to an eleventh embodiment of the present invention.

### DESCRIPTION OF THE PREFERRED EMBODIMENTS

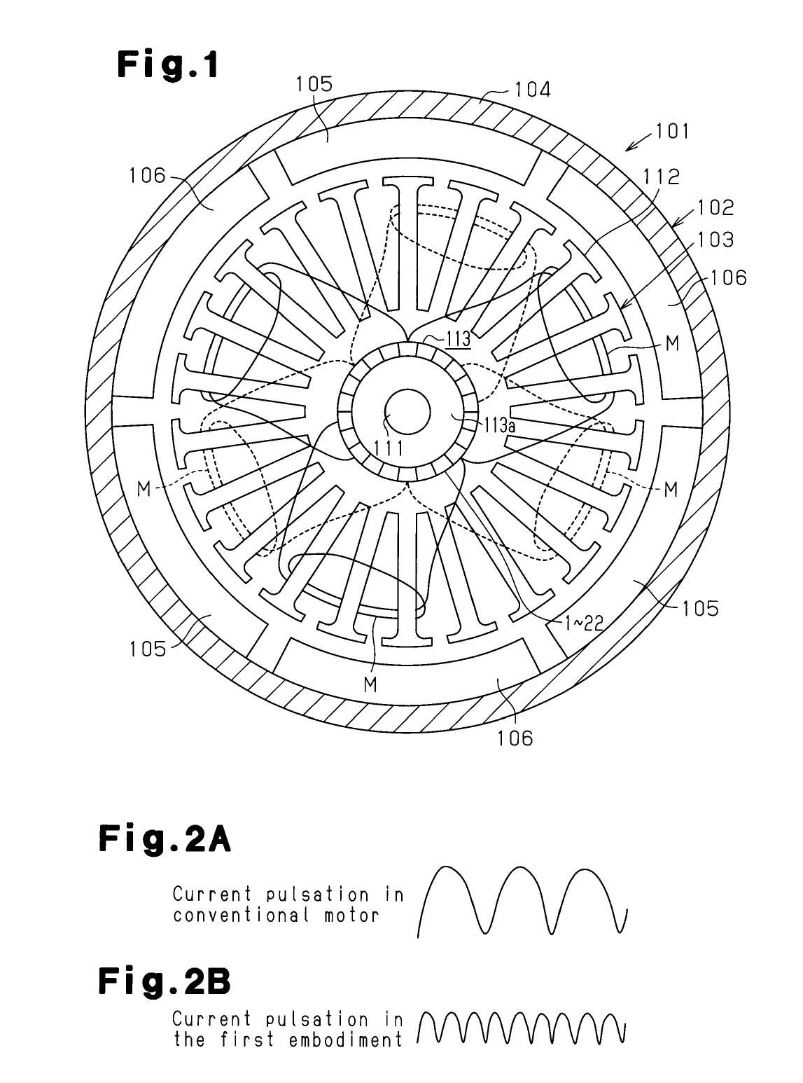

A first embodiment of the present invention will now be described with reference to FIGS. 1 to 6.

A direct current motor 101 according to the present embodiment is used for an electric power steering system, and has a stator 102 and an armature (rotor) 103 as shown in FIG. 1. The stator 102 includes a yoke housing 104 and six magnets 105, 106. The yoke housing 104 is substantially cylindrical and servers as a yoke. The magnets 105, 106 are arranged on and fixed to the inner circumferential surface of the yoke housing 104, while being arranged along the circumferential direction at equal angular intervals (60°).

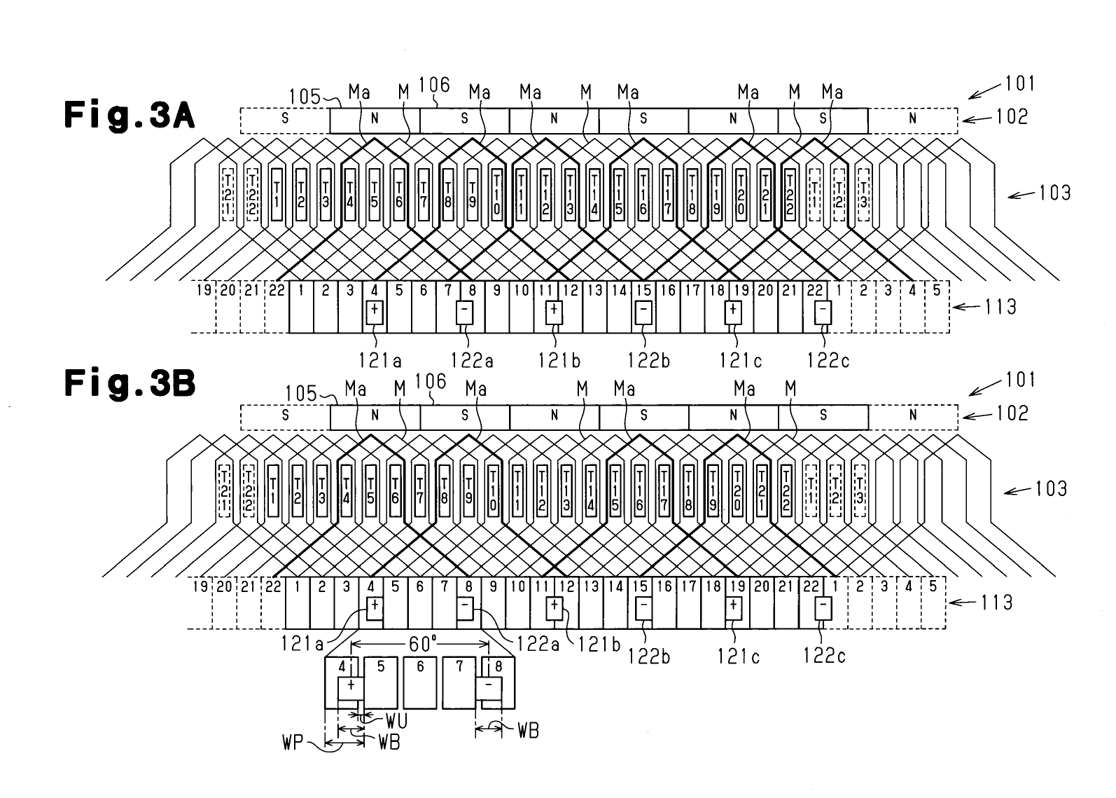

As shown in FIG. 1, the armature 103 includes a rotary shaft 111, an armature core 112, which is secured to the rotary shaft 111, and a commutator 113, which is secured to the rotary shaft 111. The rotary shaft 111 is rotatably supported by the stator 102. In this state, the armature core 112 is arranged in such manner as to face the magnets 105, 106 in a radial direction and to be surrounded by the magnets 105, 106. As shown in FIG. 3A, the stator 102 (see FIG. 1) holds positive brushes 121a to 121c and negative brushes 122a to 122c, which are slidably pressed against the outer circumference of the commutator 113.

The armature core 112 has teeth T1 to T22 (see FIG. 3A) extending radially with the rotary shaft 111 serving as the center. The number of the teeth T1 to T22 is expressed by an expression 3×N±1 (where N is an odd number greater than or equal to three). In the present embodiment, the number of the teeth is twenty-two.

The commutator 113 includes a plurality of segments 1 to 22, which are arranged on and fixed to the outer circumferential surface of an insulating body 113a (see FIG. 1), while being arranged along the circumferential direction. The number of the segments 1 to 22 is equal to the number of the teeth T1 to T22. On the outer circumference of the insulating body 113a, the segments 1 to 22 form substantially a cylinder as a whole. As shown in FIG. 3A, the positive brushes 121a to 121c and the negative brushes 122a to 122c contact (are pressed against) the radially outer surfaces of the segments 1 to 22 from the radially outer side.

Coils M are wound about the teeth T1 to T22 with insulators in between by duplex wave winding. FIG. 1 schematically shows some of the coils M. FIG. 3A is a diagrammatic developed view of the direct current motor 101.

Specifically, as shown in FIG. 3A, for example, a conducting wire is connected (hooked and fused) to the riser of the segment 1 and wound about a group of three teeth T5 to T7 in a first direction, or in a clockwise direction as viewed in FIG. 3A, to form a coil M. Thereafter, the conducting wire is connected (hooked and fused) to the riser of the segment 9. After being connected to the riser of the segment 9, the conducting wire is successively wound about three teeth T13 to T15 in the first direction to form the next coil M, and is then connected (hooked and fused) to the riser of the segment 17. After being connected to the riser of the segment 17, the conducting wire is successively wound about three teeth T21 to T1 in the first direction to form the next coil M, and is then connected (hooked and fused) to the riser of the segment 3, which is the second one from the segment 1 in the circumferential direction. In the same manner, the conducting wire is wound about groups of thee teeth other than the above described groups, while being connected to segments. As a result, a great number of coils M are wound by duplex wave winding.

The three positive brushes 121a to 121c are arranged at equal angular intervals (120°) in the circumferential direction, and the three negative brushes 122a to 122c are arranged at equal angular intervals (120°)in the circumferential direction. As shown in FIG. 3A, the positive brushes 121a to 121c and the negative brushes 122a to 122c are alternately provided at equal angular intervals (60°) in the circumferential direction. The angular width WB of the positive brushes 121a to 121c and the negative brushes 122a to 122c (the angular width at which the brushes slide on the segments 1 to 22) is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB=(2/3)×WP+WU

FIG. 3B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 22 (that is, by the angular width WP), current pulsation is generated three times, and the number of coils Ma that are short-circuited is changed between two numbers.

Specifically, when the positive brush 121a is substantially at the center in the circumferential direction of the segment 4 as shown in FIG. 3A, the short-circuited ones of the coils Ma are, as shown by thick lines in FIG. 3A, the coil Ma wound about the teeth T4 to T6, the coil Ma wound about the teeth T8 to T10, the coil Ma wound about the teeth T11 to T13, the coil Ma wound about the teeth T15 to T17, the coil Ma wound about the teeth T19 to T21, and the coil Ma wound about the teeth T22 to T2. In short, six of the coils Ma are short-circuited.

Next, when the armature 103 (the armature core 112 and the commutator 113) is slightly rotated (approximately one-sixth of the angular width WP of the pitch) as shown in FIG. 3B, the short-circuited ones of the coils Ma are, as shown by thick lines in FIG. 3B, the coil Ma wound about the teeth T4 to T6, the coil Ma wound about the teeth T8 to T10, the coil Ma wound about the teeth T15 to T17, and the coil Ma wound about the teeth T19 to T21. In short, four of the coils Ma are short-circuited.

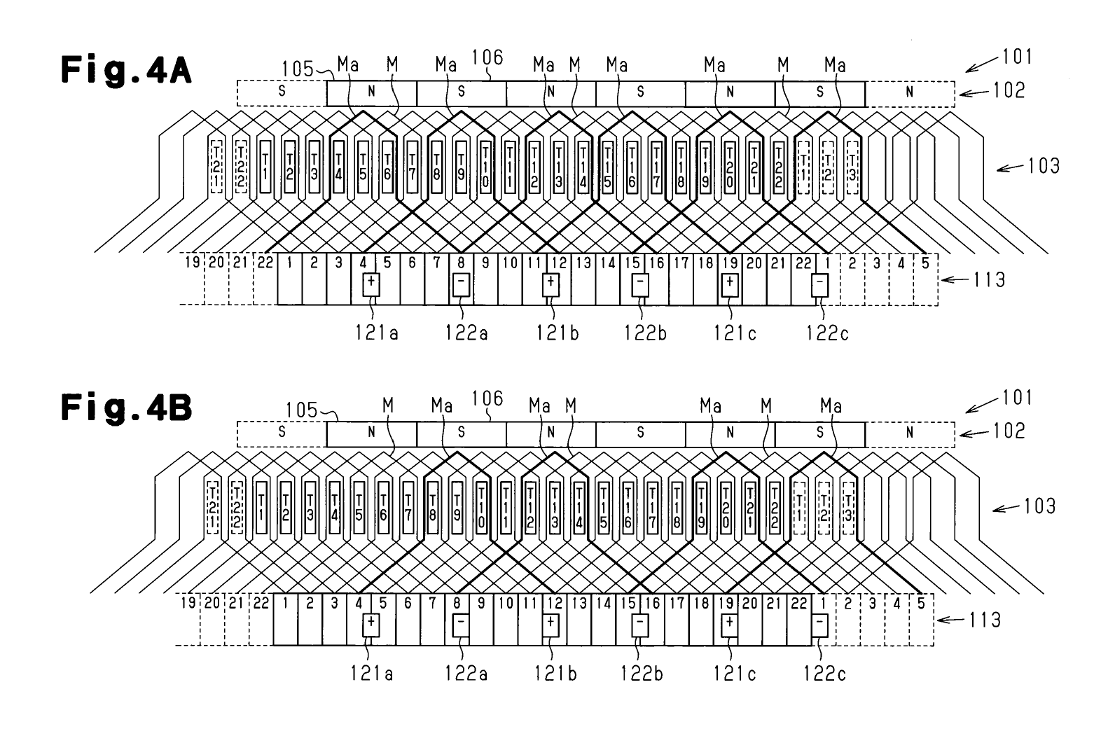

Next, when the armature 103 (the armature core 112 and the commutator 113) is slightly rotated (approximately one-sixth of the angular width WP of the pitch) as shown in FIG. 4A, the short-circuited ones of the coils Ma are, as shown by thick lines in FIG. 4A, the coil Ma wound about the teeth T4 to T6, the coil Ma wound about the teeth T8 to T10, the coil Ma wound about the teeth T12 to T14, the coil Ma wound about the teeth T15 to T17, the coil Ma wound about the teeth T19 to T21, and the coil Ma wound about the teeth T1 to T3. In short, six of the coils Ma are short-circuited.

Next, when the armature 103 (the armature core 112 and the commutator 113) is slightly rotated (approximately one-sixth of the angular width WP of the pitch) as shown in FIG. 4B, the short-circuited ones of the coils Ma are, as shown by thick lines in FIG. 4B, the coil Ma wound about the teeth T8 to T10, the coil Ma wound about the teeth T12 to T14, the coil Ma wound about the teeth T19 to T21, and the coil Ma wound about the teeth T1 to T3. In short, four of the coils Ma are short-circuited.

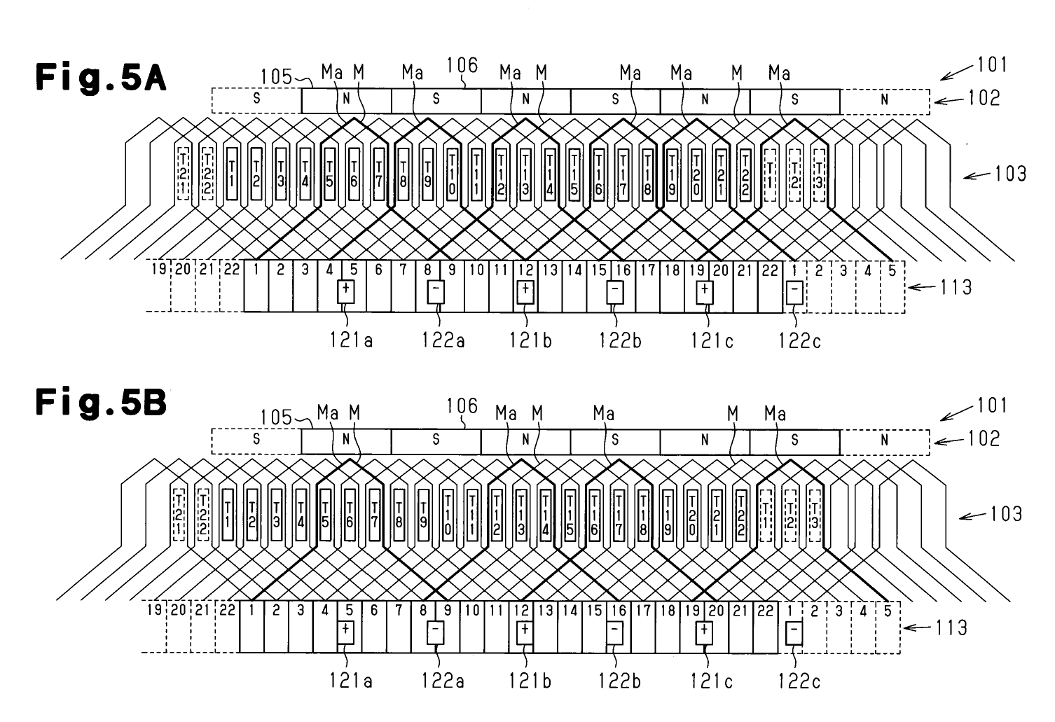

Next, when the armature 103 (the armature core 112 and the commutator 113) is slightly rotated (approximately one-sixth of the angular width WP of the pitch) as shown in FIG. 5A, the short-circuited ones of the coils Ma are, as shown by thick lines in FIG. 5A, the coil Ma wound about the teeth T5 to T7, the coil Ma wound about the teeth T8 to T10, the coil Ma wound about the teeth T12 to T14, the coil Ma wound about the teeth T16 to T18, the coil Ma wound about the teeth T19 to T21, and the coil Ma wound about the teeth T1 to T3. In short, six of the coils Ma are short-circuited.

Next, when the armature 103 (the armature core 112 and the commutator 113) is slightly rotated (approximately one-sixth of the angular width WP of the pitch) as shown in FIG. 5B, the short-circuited ones of the coils Ma are, as shown by thick lines in FIG. 5B, the coil Ma wound about the teeth T5 to T7, the coil Ma wound about the teeth T12 to T14, the coil Ma wound about the teeth T16 to T18, and the coil Ma wound about the teeth T1 to T3. In short, four of the coils Ma are short-circuited.

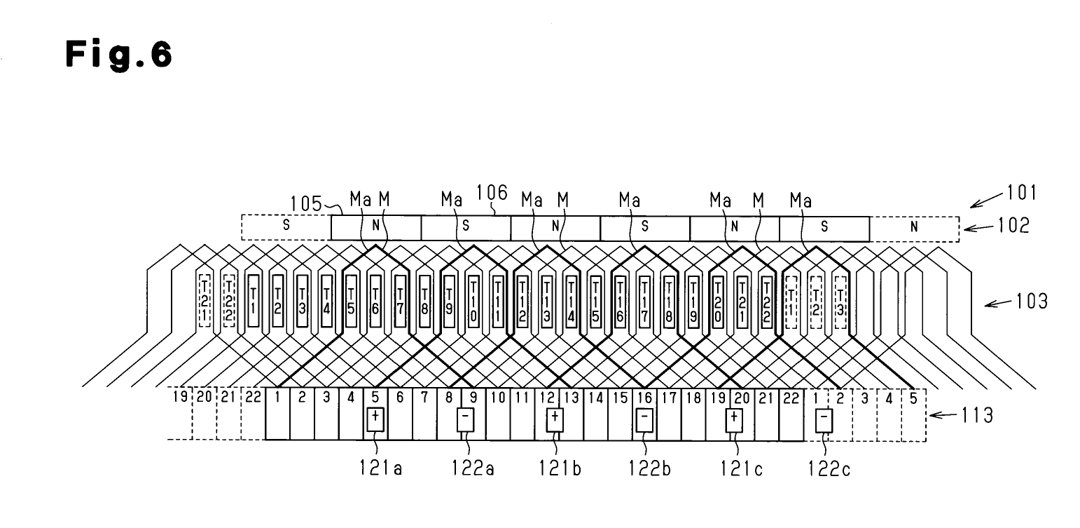

Then, when the armature 103 (the armature core 112 and the commutator 113) is slightly rotated (approximately one-sixth of the angular width WP of the pitch) as shown in FIG. 6, the positive brush 121a is substantially at the center in the circumferential direction of the segment 5. In other words, FIG. 6 shows a state in which the armature 103 has been rotated from the state shown in FIG. 3A by an amount corresponding to the arrangement pitch of the segments 1 to 22 (that is, by the angular width WP). In this case, the short-circuited ones of the coils Ma are, as shown by thick lines in FIG. 6, the coil Ma wound about the teeth T5 to T7, the coil Ma wound about the teeth T9 to T11, the coil Ma wound about the teeth T12 to T14, the coil Ma wound about the teeth T16 to T18, the coil Ma wound about the teeth T20 to T22, and the coil Ma wound about the teeth T1 to T3. In short, six of the coils Ma are short-circuited.

Thereafter, the armature 103 of the direct current motor 101 rotates while repeating the above described operation (see FIGS. 3A to 5B).

The present embodiment provides the following advantages.

(1) While the armature 103 rotates by the arrangement pitch of the segments 1 to 22 (that is, by the angular width WP), current pulsation is generated three times, and the number of coils Ma that are short-circuited is repeatedly switched between six and four. That is, the number of coils Ma that are short-circuited is changed between two numbers. By contrast, in a conventional motor, current pulsation is generated once during a rotation of the armature by the arrangement pitch of the segments, and the number of short-circuited coils is changed between six numbers. Therefore, the present embodiment reduces the torque pulsation to a lower level than the conventional motor, so that vibration and noise are reduced. FIG. 2A shows the waveform current pulsation in a conventional direct current motor, and FIG. 2B shows the waveform current pulsation in the direct current motor 101 of the present embodiment. In the present embodiment, current pulsation is generated sixty-six times while the armature 103 is rotated one turn (twenty-two times in the conventional motor), and the amplitude of the current pulsation is smaller than that of the conventional motor. Accordingly, the torque pulsation due to the current pulsation is reduced to a low level.

(2) Since the number of the teeth T1 to T22 and the number of the segments 1 to 22 are both twenty-two, the commutator 113 and the armature core 112 of a conventionally manufactured direct current motor having four magnetic poles and twenty-two teeth (four poles and twenty-two slots) can be used. This reduces the manufacturing costs including the costs for manufacturing the facility.

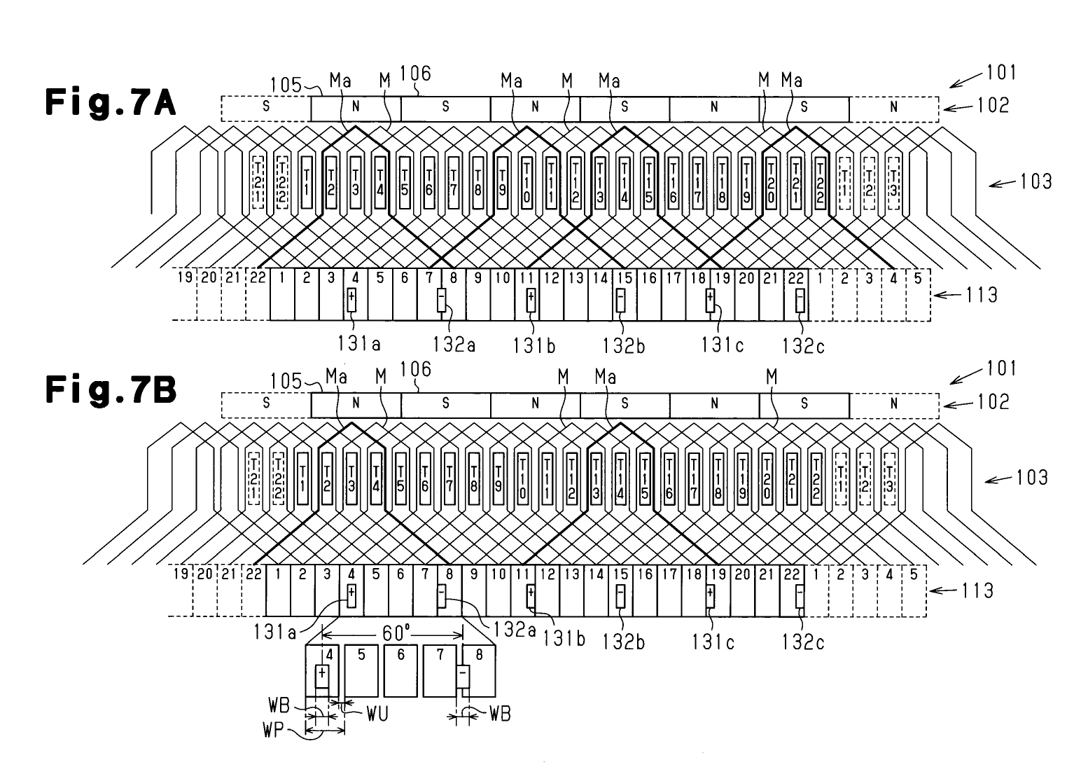

A second embodiment of the present invention will now be described with reference to FIGS. 7A to 10. In the second embodiment, like or the same reference numerals are given to those components that are like or the same as the corresponding components of the first embodiment, and detailed explanations thereof are partly omitted.

In the present embodiment, as shown in FIG. 7A, for example, a conducting wire is connected (hooked and fused) to the riser of the segment 1 and wound about a group of three teeth T3 to T5 in a first direction, or in a clockwise direction as viewed in FIG. 7A, to form a coil M. Thereafter, the conducting wire is connected (hooked and fused) to the riser of the segment 9. After being connected to the riser of the segment 9, the conducting wire is successively wound about three teeth T11 to T13 in the first direction to form the next coil M, and is then connected (hooked and fused) to the riser of the segment 17. After being connected to the riser of the segment 17, the conducting wire is successively wound about three teeth T19 to T21 in the first direction to form the next coil M, and is then connected (hooked and fused) to the riser of the segment 3, which is the second one from the segment 1 in the circumferential direction. In the same manner, the conducting wire is wound about groups of thee teeth other than the above described groups, while being connected to segments. As a result, a great number of coils M are wound about the teeth T1 to T22 by duplex wave winding.

Three positive brushes 131a to 131c are arranged at equal angular intervals (120°) in the circumferential direction, and three negative brushes 132a to 132c are arranged at equal angular intervals (120°) in the circumferential direction. As shown in FIG. 7A, the positive brushes 131a to 131c and the negative brushes 132a to 132c are alternately provided at equal angular intervals (60°) in the circumferential direction. The angular width WB of the positive brush 131a to 131c and the negative brush 132a to 132c (the angular width at which the brushes slide on the segments 1 to 22) is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB=(1/3)×WP+WU

FIG. 7B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 22 (that is, by the angular width WP), current pulsation is generated three times, and the number of coils Ma that are short-circuited is changed between two numbers.

Specifically, when the negative brush 132a is at a position where it evenly overlaps with the segments 7 and 8 as shown in FIG. 7A, the short-circuited ones of the coils Ma are, as shown by thick lines in FIG. 7A, the coil Ma wound about the teeth T2 to T4, the coil Ma wound about the teeth T9 to T11, the coil Ma wound about the teeth T13 to T15, and the coil Ma wound about the teeth T20 to T22. In short, four of the coils Ma are short-circuited.

Next, when the armature 103 (the armature core 112 and the commutator 113) is slightly rotated (approximately one-sixth of the angular width WP of the pitch) as shown in FIG. 7B, the short-circuited ones of the coils Ma are, as shown by thick lines in FIG. 7B, the coil Ma wound about the teeth T2 to T4 and the coil Ma wound about the teeth T13 to T15. In short, two of the coils Ma are short-circuited.

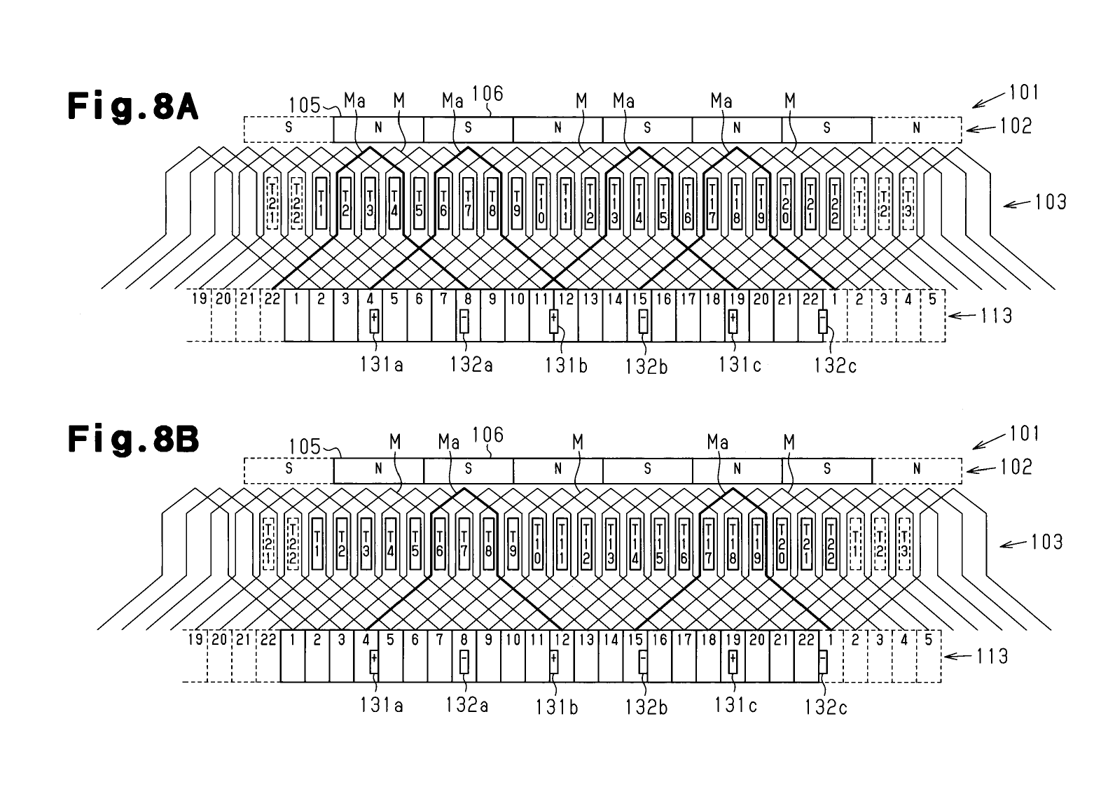

Next, when the armature 103 (the armature core 112 and the commutator 113) is slightly rotated (approximately one-sixth of the angular width WP of the pitch) as shown in FIG. 8A, the short-circuited ones of the coils Ma are, as shown by thick lines in FIG. 8A, the coil Ma wound about the teeth T2 to T4, the coil Ma wound about the teeth T6 to T8, the coil Ma wound about the teeth T13 to T15, and the coil Ma wound about the teeth T17 to T19. In short, four of the coils Ma are short-circuited.

Next, when the armature 103 (the armature core 112 and the commutator 113) is slightly rotated further (approximately one-sixth of the angular width WP of the pitch) as shown in FIG. 8B, the short-circuited ones of the coils Ma are, as shown by thick lines in FIG. 8B, the coil Ma wound about the teeth T6 to T8 and the coil Ma wound about the teeth T17 to T19. In short, two of the coils Ma are short-circuited.

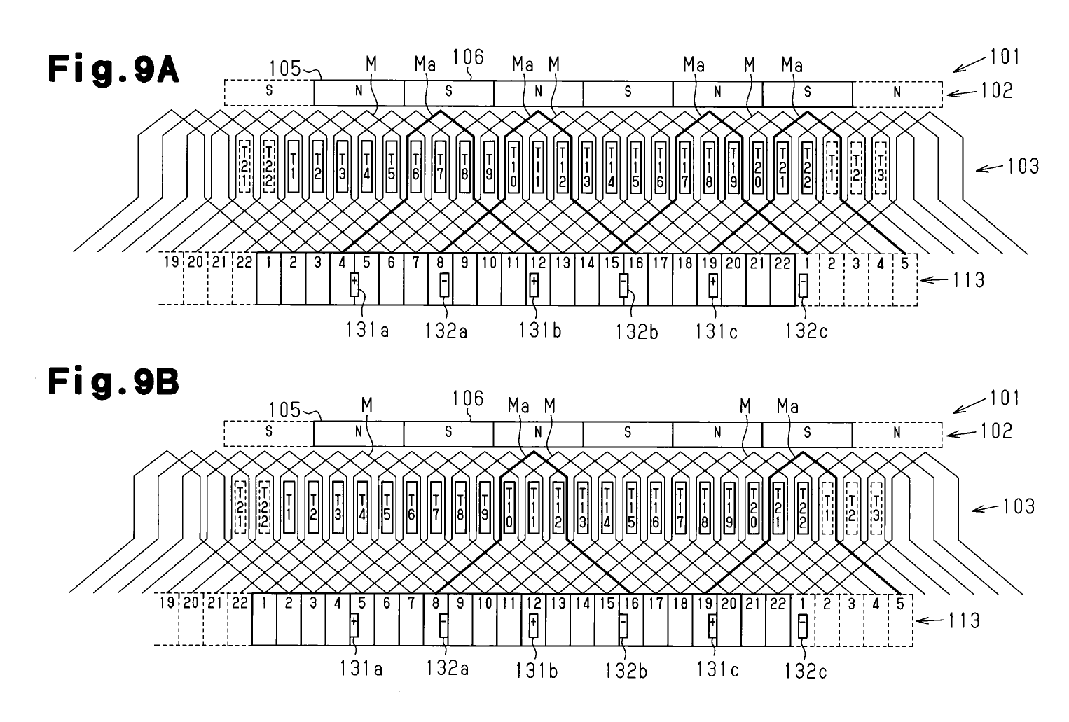

Next, when the armature 103 (the armature core 112 and the commutator 113) is slightly rotated (approximately one-sixth of the angular width WP of the pitch) as shown in FIG. 9A, the short-circuited ones of the coils Ma are, as shown by thick lines in FIG. 9A, the coil Ma wound about the teeth T6 to T8, the coil Ma wound about the teeth T10 to T12, the coil Ma wound about the teeth T17 to T19, and the coil Ma wound about the teeth T21 to T1. In short, four of the coils Ma are short-circuited.

Next, when the armature 103 (the armature core 112 and the commutator 113) is slightly rotated further (approximately one-sixth of the angular width WP of the pitch) as shown in FIG. 9B, the short-circuited ones of the coils Ma are, as shown by thick lines in FIG. 9B, the coil Ma wound about the teeth T10 to T12 and the coil Ma wound about the teeth T21 to T1. In short, two of the coils Ma are short-circuited.

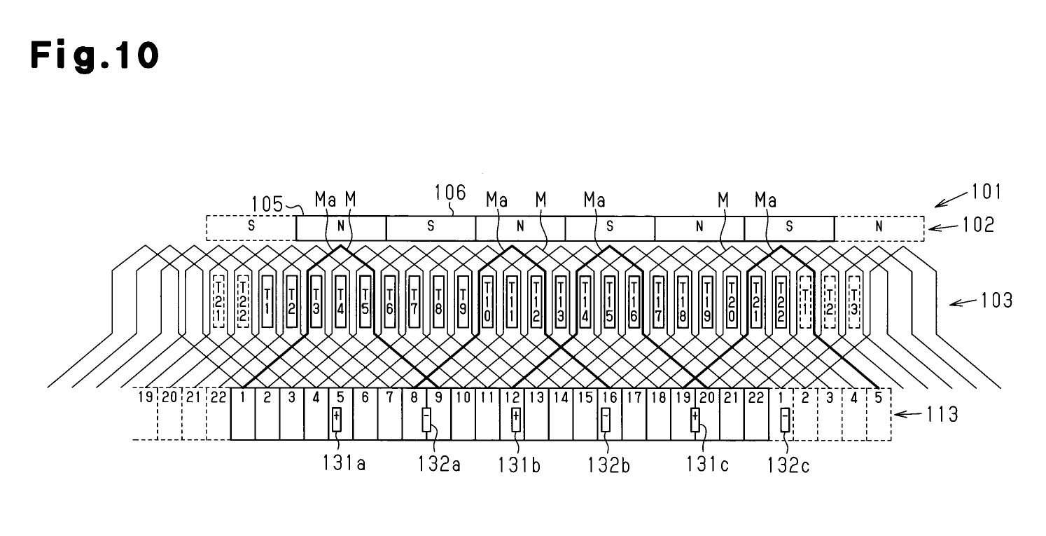

Then, when the armature 103 (the armature core 112 and the commutator 113) is slightly rotated further (approximately one-sixth of the angular width WP of the pitch) as shown in FIG. 10, the negative brush 132a is at a position where it evenly overlaps with the segments 8 and 9. In other words, FIG. 10 shows a state in which the armature 103 has been rotated from the state shown in FIG. 7A by an amount corresponding to the arrangement pitch of the segments 1 to 22 (that is, by the angular width WP). In this case, the short-circuited ones of the coils Ma are, as shown by thick lines in FIG. 10, the coil Ma wound about the teeth T3 to T5, the coil Ma wound about the teeth T10 to T12, the coil Ma wound about the teeth T14 to T16, and the coil Ma wound about the teeth T21 to T1. In short, four of the coils Ma are short-circuited.

Thereafter, the armature 103 of the direct current motor 101 rotates while repeating the above described operation (see FIGS. 7A to 9B).

The present embodiment provides the following advantages.

(3) While the armature 103 rotates by the arrangement pitch of the segments 1 to 22 (that is, by the angular width WP), current pulsation is generated three times, and the number of coils Ma that are short-circuited is repeatedly switched between four and two. That is, the number of coils Ma that are short-circuited is changed between two numbers. Therefore, the present embodiment reduces the torque pulsation to a lower level than the conventional motor, so that vibration and noise are reduced. Also, in the present embodiment, the maximum number of the short-circuited coils Ma is four. Thus, the number of the coils M that are not short-circuited is greater than the first embodiment, in which the maximum number is six. Accordingly, the efficiency is further improved.

(4) Since the number of the teeth T1 to T22 and the number of the segments 1 to 22 are both twenty-two, the commutator 113 and the armature core 112 of a conventionally manufactured direct current motor having four magnetic poles and twenty-two teeth (four poles and twenty-two slots) can be used. This reduces the manufacturing costs including the costs for manufacturing the facility.

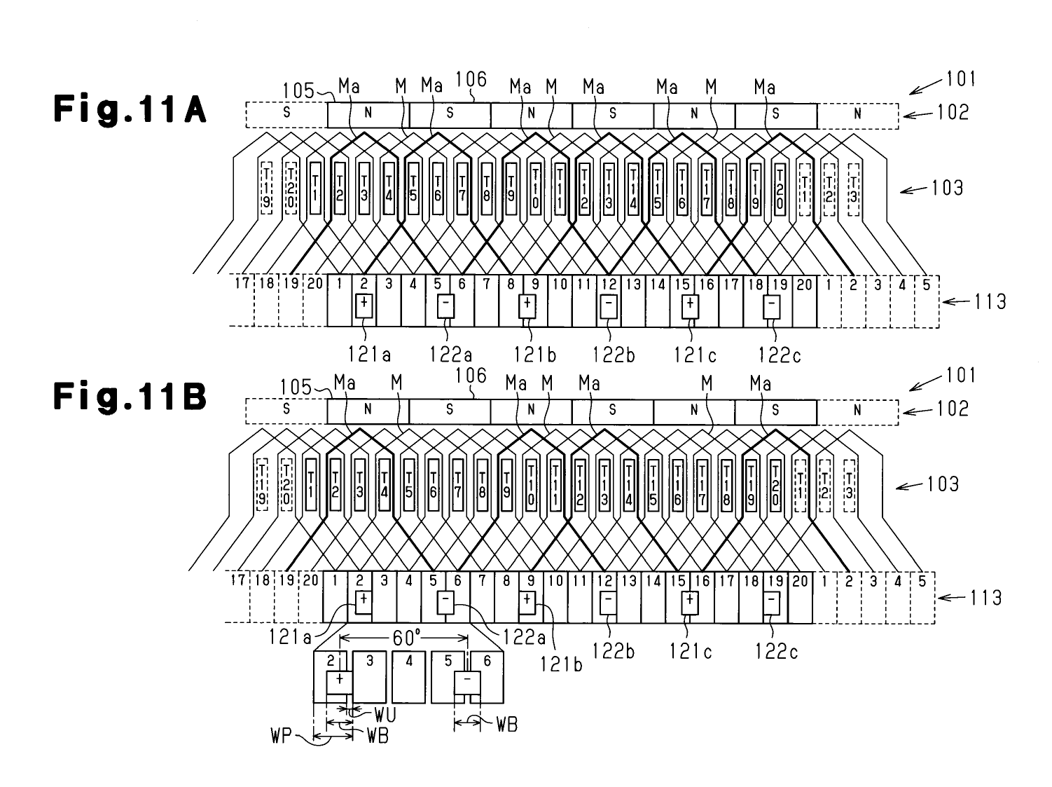

A third embodiment of the present invention will now be described with reference to FIGS. 11A to 14. In the third embodiment, like or the same reference numerals are given to those components that are like or the same as the corresponding components of the first embodiment, and detailed explanations thereof are partly omitted.

As shown in FIG. 11A, an armature core 112 of the present embodiment has twenty teeth T1 to T20.

A commutator 113 includes segments 1 to 20, the number of which is equal to the number of the teeth T1 to T20.

In the present embodiment, as shown in FIG. 11A, for example, a conducting wire is connected (hooked and fused) to the riser of the segment 1 and wound about a group of three teeth T4 to T6 in a first direction, or in a clockwise direction as viewed in FIG. 11A, to form a coil M. Thereafter, the conducting wire is connected (hooked and fused) to the riser of the segment 7. After being connected to the riser of the segment 7, the conducting wire is successively wound about three teeth T10 to T12 in the first direction to form the next coil M, and is then connected (hooked and fused) to the riser of the segment 13. After being connected to the riser of the segment 13, the conducting wire is successively wound about three teeth T16 to T18 in the first direction to form the next coil M, and is then connected (hooked and fused) to the riser of the segment 19, which is the second one from the segment 1 in the circumferential direction. In the same manner, the conducting wire is wound about groups of thee teeth other than the above described groups, while being connected to segments. As a result, a great number of coils M are wound about the teeth T1 to T20 by duplex wave winding.

Three positive brushes 121a to 121c are arranged at equal angular intervals (120°) in the circumferential direction, and three negative brushes 122a to 122c are arranged at equal angular intervals (120°) in the circumferential direction. As shown in FIG. 11A, the positive brushes 131a to 131c and the negative brushes 132a to 132c are alternately provided at equal angular intervals (60°) in the circumferential direction. As in the first embodiment, the angular width WB of the positive brushes 121a to 121c and the negative brushes 122a to 122c (the angular width at which the brushes slide on the segments 1 to 20) is set to satisfy the following expression, when the angular width of the arrangement pitch of the segments 1 to 20 is represented by WP (WP=360°/the number of segments (twenty in the present embodiment)), and the angular width of the clearance between each adjacent pair of the segments 1 to 20 is represented by WU.

WB=(2/3)×WP+WU

FIG. 11B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 20 (that is, by the angular width WP), current pulsation is generated three times, and the number of coils Ma that are short-circuited is changed between two numbers.

Specifically, when the positive brush 121a is substantially at the center in the circumferential direction of the segment 2 as shown in FIG. 11A, the short-circuited ones of the coils Ma are, as shown by thick lines in FIG. 11A, the coil Ma wound about the teeth T2 to T4, the coil Ma wound about the teeth T5 to T7, the coil Ma wound about the teeth T9 to T11, the coil Ma wound about the teeth T12 to T14, the coil Ma wound about the teeth T15 to T17, and the coil Ma wound about the teeth T19 to T1. In short, six of the coils Ma are short-circuited.

Next, when the armature 103 (the armature core 112 and the commutator 113) is slightly rotated (approximately one-sixth of the angular width WP of the pitch) as shown in FIG. 11B, the short-circuited ones of the coils Ma are, as shown by thick lines in FIG. 11B, the coil Ma wound about the teeth T2 to T4, the coil Ma wound about the teeth T9 to T11, the coil Ma wound about the teeth T12 to T14, and the coil Ma wound about the teeth T19 to T1. In short, four of the coils Ma are short-circuited.

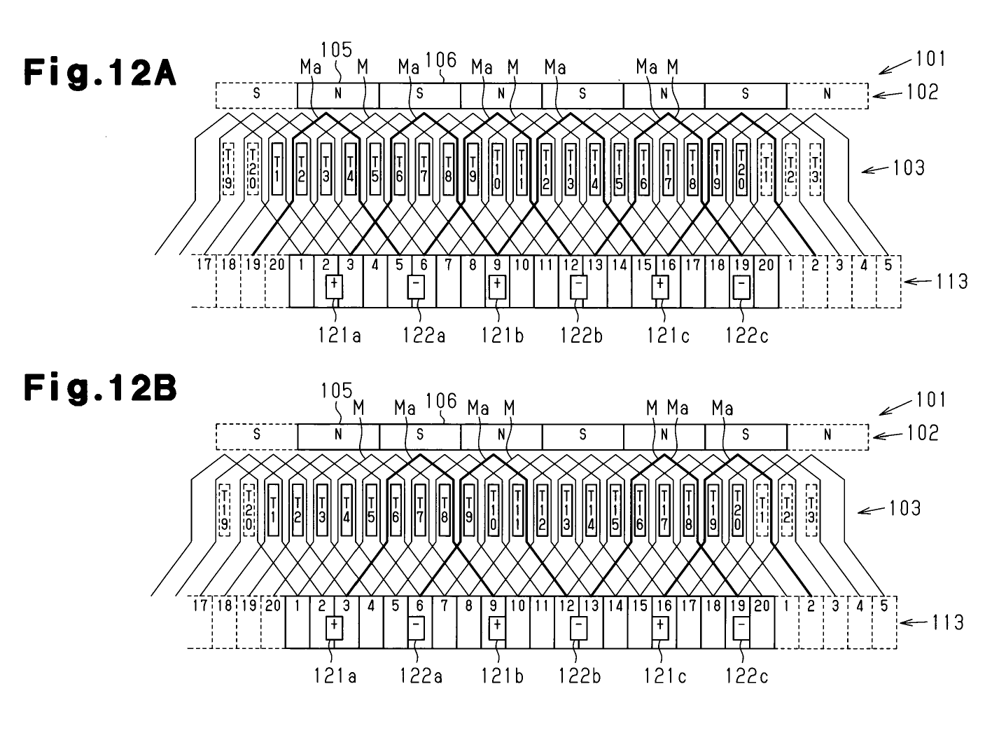

Next, when the armature 103 (the armature core 112 and the commutator 113) is slightly rotated (approximately one-sixth of the angular width WP of the pitch) as shown in FIG. 12A, the short-circuited ones of the coils Ma are, as shown by thick lines in FIG. 11A, the coil Ma wound about the teeth T2 to T4, the coil Ma wound about the teeth T6 to T8, the coil Ma wound about the teeth T9 to T11, the coil Ma wound about the teeth T12 to T14, the coil Ma wound about the teeth T16 to T18, and the coil Ma wound about the teeth T19 to T1. In short, six of the coils Ma are short-circuited.

Next, when the armature 103 (the armature core 112 and the commutator 113) is slightly rotated (approximately one-sixth of the angular width WP of the pitch) as shown in FIG. 12B, the short-circuited ones of the coils Ma are, as shown by thick lines in FIG. 12B, the coil Ma wound about the teeth T6 to T8, the coil Ma wound about the teeth T9 to T11, the coil Ma wound about the teeth T16 to T18, and the coil Ma wound about the teeth T19 to T1. In short, four of the coils Ma are short-circuited.

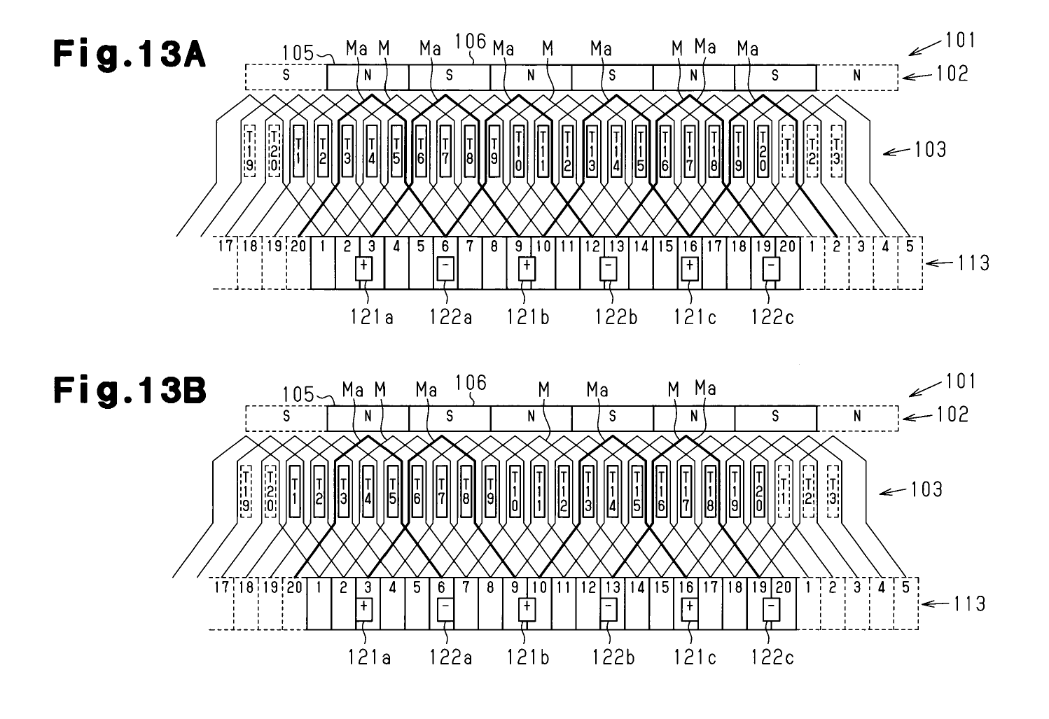

Next, when the armature 103 (the armature core 112 and the commutator 113) is slightly rotated (approximately one-sixth of the angular width WP of the pitch) as shown in FIG. 13A, the short-circuited ones of the coils Ma are, as shown by thick lines in FIG. 13A, the coil Ma wound about the teeth T3 to T5, the coil Ma wound about the teeth T6 to T8, the coil Ma wound about the teeth T9 to T11, the coil Ma wound about the teeth T13 to T15, the coil Ma wound about the teeth T16 to T18, and the coil Ma wound about the teeth T19 to T1. In short, six of the coils Ma are short-circuited.

Next, when the armature 103 (the armature core 112 and the commutator 113) is slightly rotated (approximately one-sixth of the angular width WP of the pitch) as shown in FIG. 13B, the short-circuited ones of the coils Ma are, as shown by thick lines in FIG. 13B, the coil Ma wound about the teeth T3 to T5, the coil Ma wound about the teeth T6 to T8, the coil Ma wound about the teeth T13 to T15, and the coil Ma wound about the teeth T16 to T18. In short, four of the coils Ma are short-circuited.

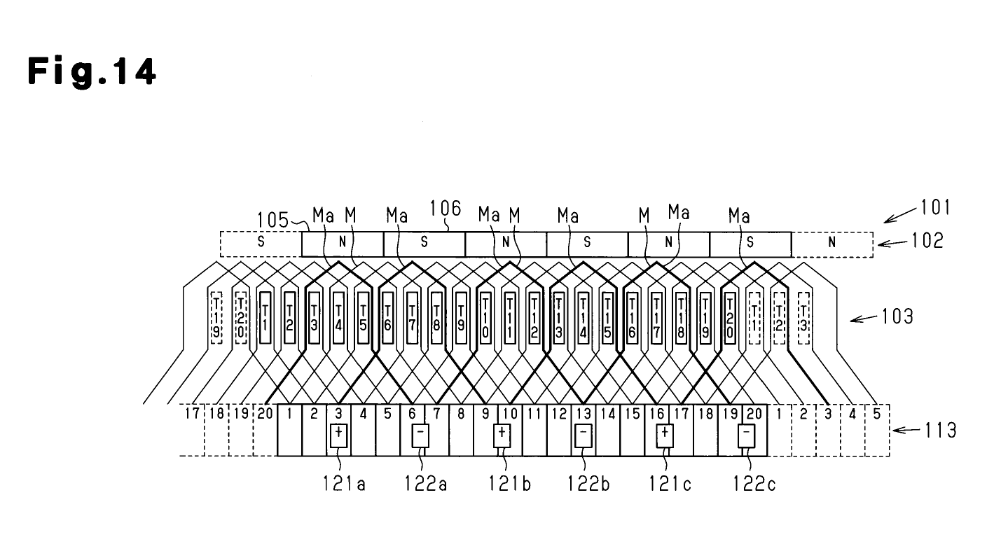

Then, when the armature 103 (the armature core 112 and the commutator 113) is slightly rotated (approximately one-sixth of the angular width WP of the pitch) as shown in FIG. 14, the positive brush 121a is substantially at the center in the circumferential direction of the segment 3. That is, when the armature 103 is rotated from the state shown in FIG. 11B by the amount corresponding to the arrangement pitch of the segments 1 to 20 (that is, by the angular width WP), the short-circuited ones of the coils Ma are, as shown by thick lines in FIG. 14, the coil Ma wound about the teeth T3 to T5, the coil Ma wound about the teeth T6 to T8, the coil Ma wound about the teeth T10 to T12, the coil Ma wound about the teeth T13 to T15, the coil Ma wound about the teeth T16 to T18, and the coil Ma wound about the teeth T20 to T2. In short, six of the coils Ma are short-circuited.

Thereafter, the armature 103 of the direct current motor 101 rotates while repeating the above described operation (see FIGS. 11A to 13B).

The present embodiment provides the following advantages.

(5) While the armature 103 rotates by the arrangement pitch of the segments 1 to 20 (that is, by the angular width WP), current pulsation is generated three times, and the number of coils Ma that are short-circuited is repeatedly switched between six and four. That is, the number of coils Ma that are short-circuited is changed between two numbers. Therefore, the present embodiment reduces the torque pulsation to a lower level than the conventional motor, so that vibration and noise are reduced.

(6) Since the number of the teeth T1 to T20 and the number of the segments 1 to 20 are both twenty, the angular width WB of the positive brushes 121a to 121c and the negative brushes 122a to 122c is greater than that in the first embodiment. Accordingly, the output can be increased by a large current.

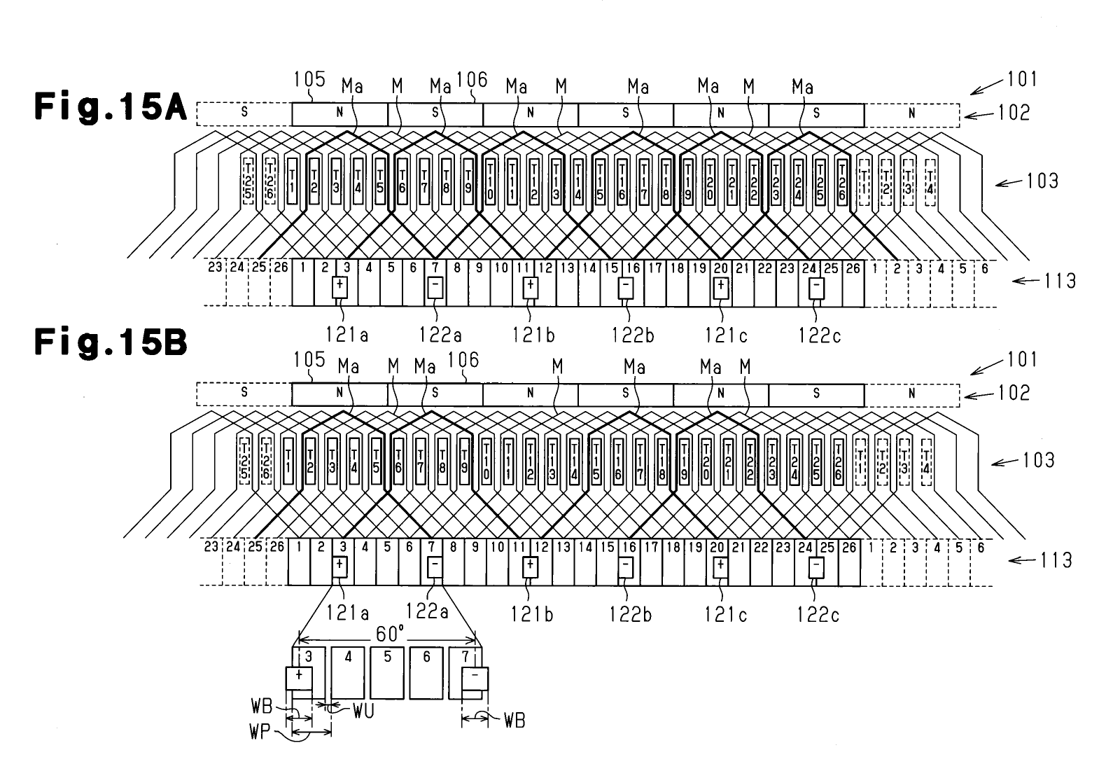

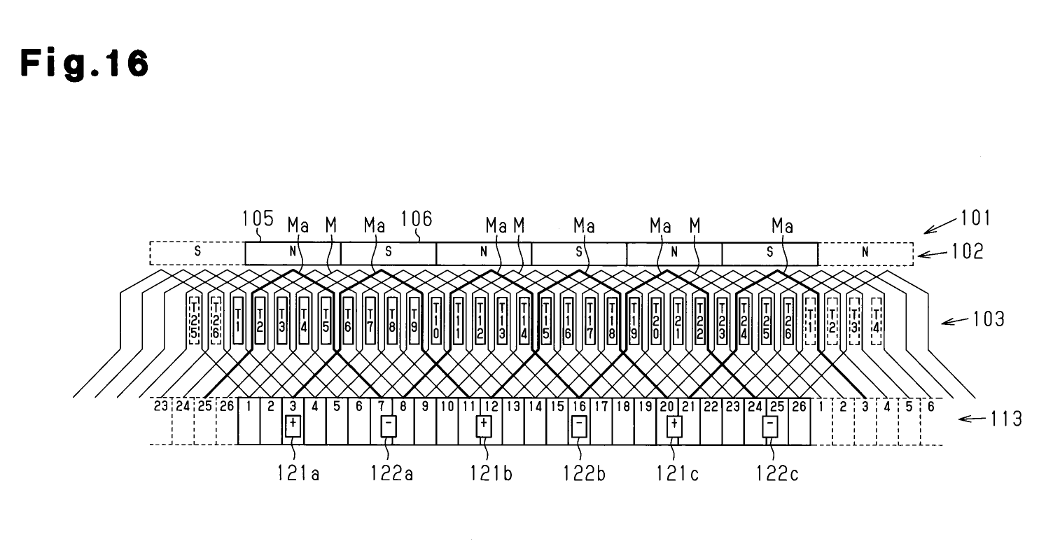

A fourth embodiment of the present invention will now be described with reference to FIGS. 15A to 16. In the fourth embodiment, like or the same reference numerals are given to those components that are like or the same as the corresponding components of the first embodiment, and detailed explanations thereof are partly omitted.

As shown in FIG. 15A, an armature core 112 of the present embodiment has twenty-six teeth T1 to T26.

A commutator 113 includes segments 1 to 26, the number of which is equal to the number of the teeth T1 to T26.

In the present embodiment, as shown in FIG. 15A, for example, a conducting wire is connected (hooked and fused) to the riser of the segment 1 and wound about a group of four teeth T4 to T7 in a first direction, or in a clockwise direction as viewed in FIG. 15A, to form a coil M. Thereafter, the conducting wire is connected (hooked and fused) to the riser of the segment 9. After being connected to the riser of the segment 9, the conducting wire is successively wound about four teeth T12 to T15 in the first direction to form the next coil M, and is then connected (hooked and fused) to the riser of the segment 17. After being connected to the riser of the segment 17, the conducting wire is successively wound about three teeth T20 to T23 in the first direction to form the next coil M, and is then connected (hooked and fused) to the riser of the segment 25, which is the second one from the segment 1 in the circumferential direction. In the same manner, the conducting wire is wound about groups of four teeth other than the above described groups, while being connected to segments. As a result, a great number of coils M are wound about the teeth T1 to T26 by duplex wave winding.

Three positive brushes 121a to 121c are arranged at equal angular intervals (120°) in the circumferential direction, and three negative brushes 122a to 122c are arranged at equal angular intervals (120°) in the circumferential direction. As shown in FIG. 15A, the positive brushes 121a to 121c and the negative brushes 122a to 122c are alternately provided at equal angular intervals (60°) in the circumferential direction. As in the first embodiment, the angular width WB of the positive brushes 121a to 121c and the negative brushes 122a to 122c (the angular width at which the brushes slide on the segments 1 to 22) is set to satisfy the following expression, when the angular width of the arrangement pitch of the segments 1 to 26 is represented by WP (WP=360°/the number of segments (twenty-six in the present embodiment)), and the angular width of the clearance between each adjacent pair of the segments 1 to 26 is represented by WU.

WB=(2/3)×WP+WU

FIG. 15B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 26 (that is, by the angular width WP), current pulsation is generated three times, and the number of coils Ma that are short-circuited is changed between two numbers.

Specifically, when the negative brush 122a is substantially at the center in the circumferential direction of the segment 7 as shown in FIG. 15A, the short-circuited ones of the coils Ma are, as shown by thick lines in FIG. 15A, the coil Ma wound about the teeth T2 to T5, the coil Ma wound about the teeth T6 to T9, the coil Ma wound about the teeth T10 to T13, the coil Ma wound about the teeth T15 to T18, the coil Ma wound about the teeth T19 to T22, and the coil Ma wound about the teeth T23 to T26. In short, six of the coils Ma are short-circuited.

Next, when the armature 103 (the armature core 112 and the commutator 113) is slightly rotated (approximately one-sixth of the angular width WP of the pitch) as shown in FIG. 15B, the short-circuited ones of the coils Ma are, as shown by thick lines in FIG. 15B, the coil Ma wound about the teeth T2 to T5, the coil Ma wound about the teeth T6 to T9, the coil Ma wound about the teeth T15 to T18, and the coil Ma wound about the teeth T19 to T22. In short, four of the coils Ma are short-circuited.

Next, when the armature 103 (the armature core 112 and the commutator 113) is slightly rotated (approximately one-sixth of the angular width WP of the pitch) as shown in FIG. 16, the short-circuited ones of the coils Ma are, as shown by thick lines in FIG. 16, the coil Ma wound about the teeth T2 to T5, the coil Ma wound about the teeth T6 to T9, the coil Ma wound about the teeth T11 to T14, the coil Ma wound about the teeth T15 to T18, the coil Ma wound about the teeth T19 to T22, and the coil Ma wound about the teeth T24 to T1. In short, six of the coils Ma are short-circuited.

Thereafter, the armature 103 of the direct current motor 101 rotates while repeating the above described operation (see FIGS. 15A to 16B).

The present embodiment provides the following advantages.

(7) While the armature 103 rotates by the arrangement pitch of the segments 1 to 26 (that is, by the angular width WP), current pulsation is generated three times, and the number of coils Ma that are short-circuited is repeatedly switched between six and four. That is, the number of coils Ma that are short-circuited is changed between two numbers. Therefore, the torque pulsation is reduced to a lower level than the conventional motor, so that vibration and noise are reduced.

(8) Since the number of the teeth T1 to T26 and the number of the segments 1 to 26 are both twenty-six, the number of the coils Ma is increased and the number of turns of each oil M is reduced compared to the configuration of the first embodiment. Further, commutation arc is inhibited and current pulsation is fragmented (current pulsation is generated seventy-eight times while the armature 103 (the armature core 112 and the commutator 113) is rotated one turn). This further reduces vibration and noise.

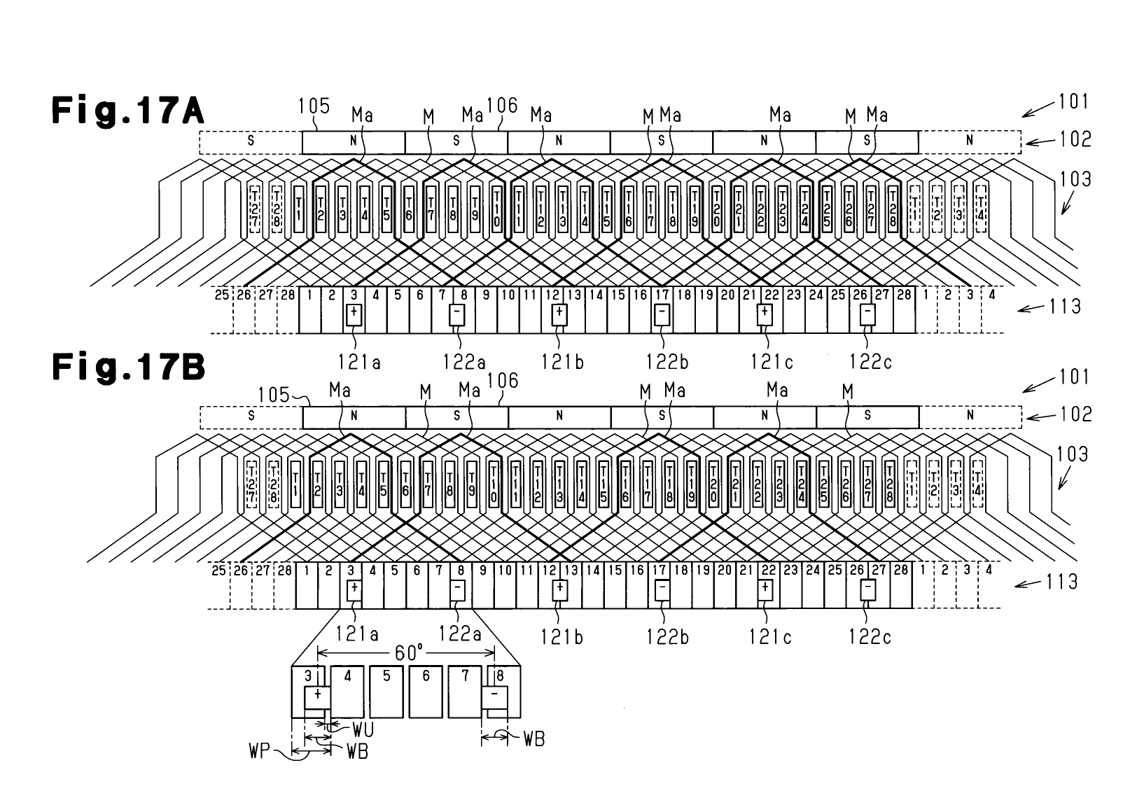

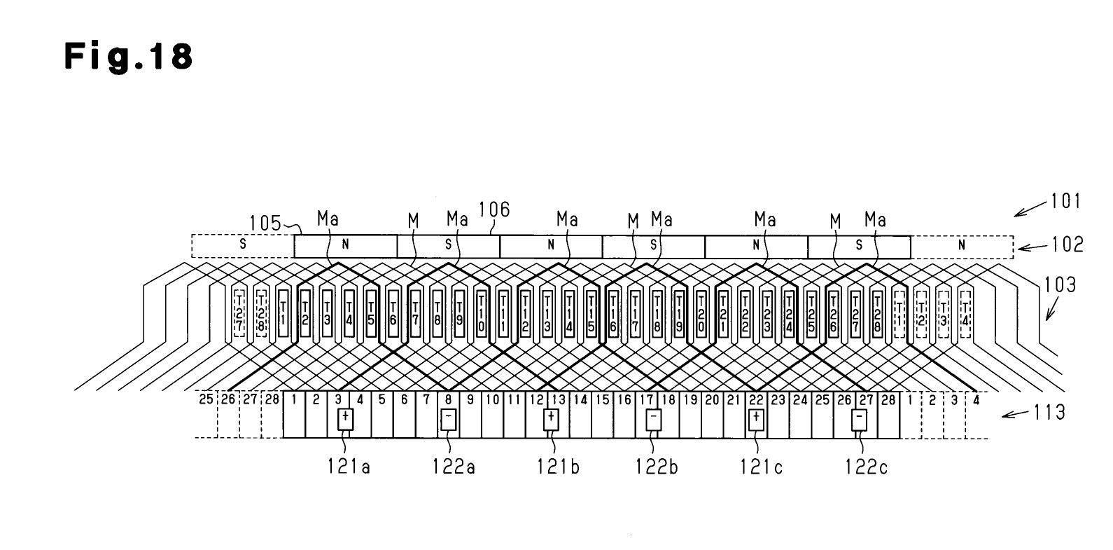

A fifth embodiment of the present invention will now be described with reference to FIGS. 17A to 18. In the fifth embodiment, like or the same reference numerals are given to those components that are like or the same as the corresponding components of the first embodiment, and detailed explanations thereof are partly omitted.

As shown in FIG. 17A, an armature core 112 of the present embodiment has twenty-eight teeth T1 to T28.

A commutator 113 includes segments 1 to 28, the number of which is equal to the number of the teeth T1 to T28.

In the present embodiment, as shown in FIG. 17A, for example, a conducting wire is connected (hooked and fused) to the riser of the segment 1 and wound about a group of four teeth T5 to T8 in a first direction, or in a clockwise direction as viewed in FIG. 17A, to form a coil M. Thereafter, the conducting wire is connected (hooked and fused) to the riser of the segment 11. After being connected to the riser of the segment 11, the conducting wire is successively wound about four teeth T15 to T18 in the first direction to form the next coil M, and is then connected (hooked and fused) to the riser of the segment 21. After being connected to the riser of the segment 21, the conducting wire is successively wound about four teeth T25 to T28 in the first direction to form the next coil M, and is then connected (hooked and fused) to the riser of the segment 3, which is the second one from the segment 1 in the circumferential direction. In the same manner, the conducting wire is wound about groups of four teeth other than the above described groups, while being connected to segments. As a result, a great number of coils M are wound about the teeth T1 to T28 by duplex wave winding.

Three positive brushes 121a to 121c are arranged at equal angular intervals (120°) in the circumferential direction, and three negative brushes 122a to 122c are arranged at equal angular intervals (120°) in the circumferential direction. As shown in FIG. 17A, the positive brushes 121a to 121c and the negative brushes 122a to 122c are alternately provided at equal angular intervals (60°) in the circumferential direction. As in the first embodiment, the angular width WB of the positive brushes 121a to 121c and the negative brushes 122a to 122c (the angular width at which the brushes slide on the segments 1 to 28) is set to satisfy the following expression, when the angular width of the arrangement pitch of the segments 1 to 28 is represented by WP (WP=360°/the number of segments (twenty-eight in the present embodiment)), and the angular width of the clearance between each adjacent pair of the segments 1 to 28 is represented by WU.

WB=(2/3)×WP+WU

FIG. 17B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 28 (that is, by the angular width WP), current pulsation is generated three times, and the number of coils Ma that are short-circuited is changed between two numbers.

Specifically, when the positive brush 121a is substantially at the center in the circumferential direction of the segment 3 as shown in FIG. 17A, the short-circuited ones of the coils Ma are, as shown by thick lines in FIG. 17A, the coil Ma wound about the teeth T2 to T5, the coil Ma wound about the teeth T7 to T10, the coil Ma wound about the teeth T11 to T14, the coil Ma wound about the teeth T16 to T19, the coil Ma wound about the teeth T21 to T24, and the coil Ma wound about the teeth T25 to T28. In short, six of the coils Ma are short-circuited.

Next, when the armature 103 (the armature core 112 and the commutator 113) is slightly rotated (approximately one-sixth of the angular width WP of the pitch) as shown in FIG. 17B, the short-circuited ones of the coils Ma are, as shown by thick lines in FIG. 17B, the coil Ma wound about the teeth T2 to T5, the coil Ma wound about the teeth T7 to T10, the coil Ma wound about the teeth T16 to T19, and the coil Ma wound about the teeth T21 to T24. In short, four of the coils Ma are short-circuited.

Next, when the armature 103 (the armature core 112 and the commutator 113) is slightly rotated (approximately one-sixth of the angular width WP of the pitch) as shown in FIG. 18, the short-circuited ones of the coils Ma are, as shown by thick lines in FIG. 18, the coil Ma wound about the teeth T2 to T5, the coil Ma wound about the teeth T7 to T10, the coil Ma wound about the teeth T12 to T15, the coil Ma wound about the teeth T16 to T19, the coil Ma wound about the teeth T21 to T24, and the coil Ma wound about the teeth T26 to T1. In short, six of the coils Ma are short-circuited.

Thereafter, the armature 103 of the direct current motor 101 rotates while repeating the above described operation (see FIGS. 17A to 18B).

The present embodiment provides the following advantages.

(9) While the armature 103 rotates by the arrangement pitch of the segments 1 to 28 (that is, by the angular width WP), current pulsation is generated three times, and the number of coils Ma that are short-circuited is repeatedly switched between six and four. That is, the number of coils Ma that are short-circuited is changed between two numbers. Therefore, the present embodiment reduces the torque pulsation to a lower level than the conventional motor, so that vibration and noise are reduced.

(10) Since the number of the teeth T1 to T28 and the number of the segments 1 to 28 are both twenty-eight, the number of the coils Ma is increased and the number of turns of each oil M is reduced compared to the configuration of the first embodiment. Further, commutation arc is inhibited and current pulsation is fragmented (current pulsation is generated seventy-eight times while the armature 103 is rotated one turn). This further reduces vibration and noise.

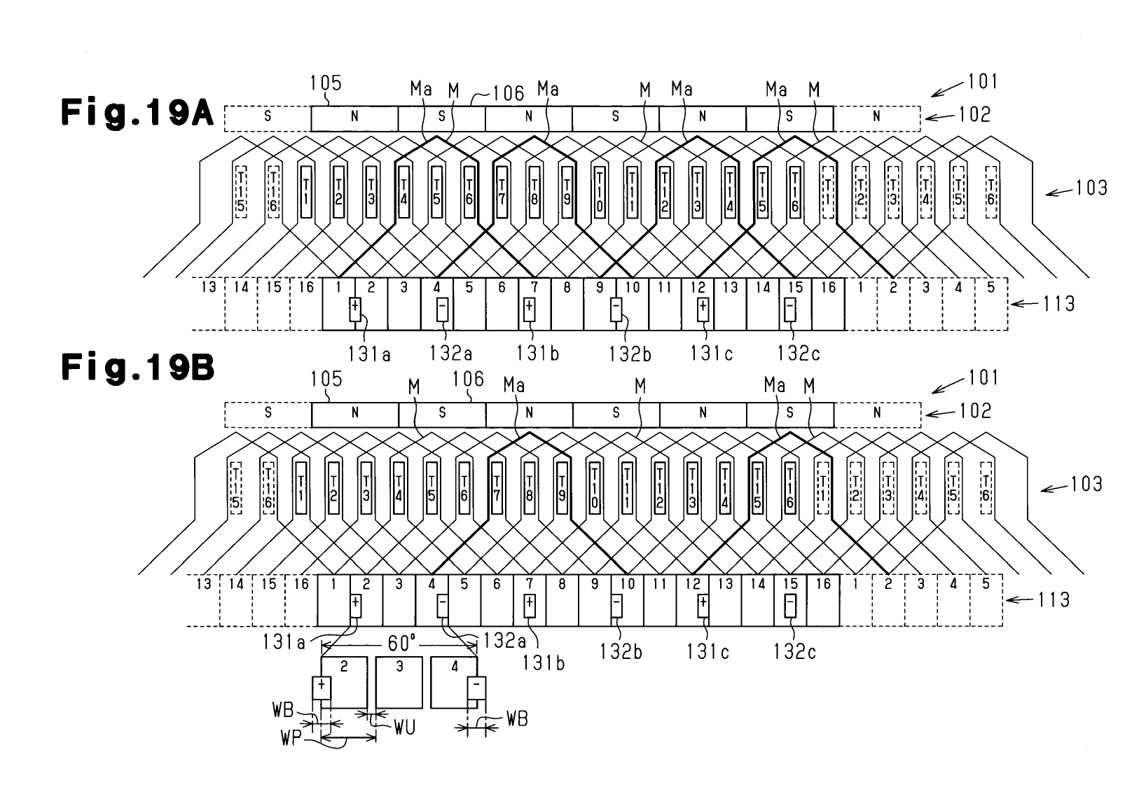

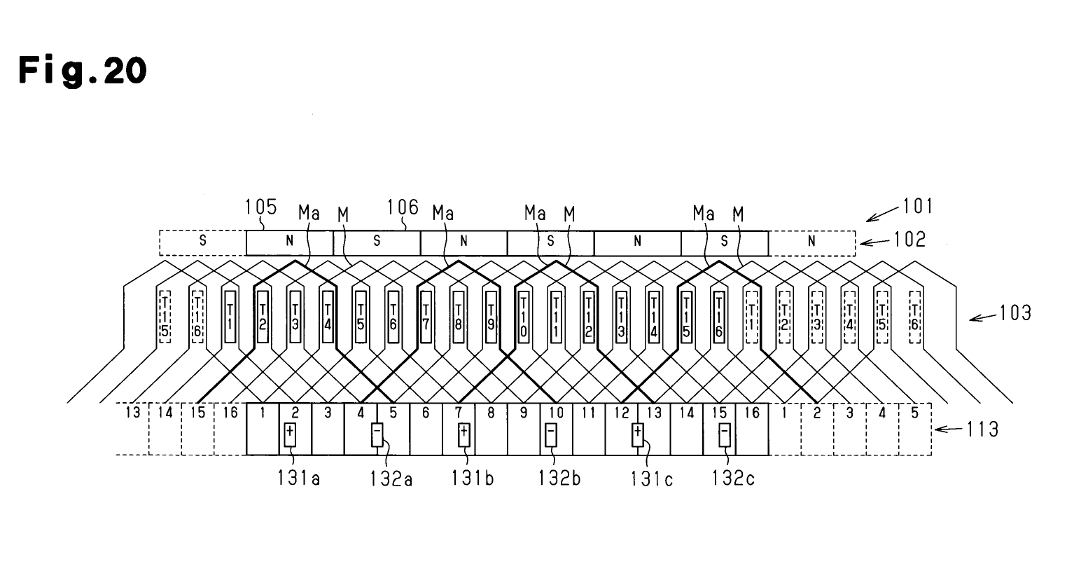

A sixth embodiment of the present invention will now be described with reference to FIGS. 19A to 20. In the sixth embodiment, like or the same reference numerals are given to those components that are like or the same as the corresponding components of the first embodiment, and detailed explanations thereof are partly omitted.

As shown in FIG. 19A, an armature core 112 of the present embodiment has sixteen teeth T1 to T16.

A commutator 113 includes segments 1 to 16, the number of which is equal to the number of the teeth T1 to T16.

In the present embodiment, as shown in FIG. 19A, for example, a conducting wire is connected (hooked and fused) to the riser of the segment 1 and wound about a group of three teeth T4 to T6 in a first direction, or in a clockwise direction as viewed in FIG. 19A, to form a coil M. Thereafter, the conducting wire is connected (hooked and fused) to the riser of the segment 7. After being connected to the riser of the segment 7, the conducting wire is successively wound about three teeth T10 to T12 in the first direction to form the next coil M, and is then connected (hooked and fused) to the riser of the segment 13. After being connected to the riser of the segment 13, the conducting wire is successively wound about three teeth T16 to T2 in the first direction to form the next coil Ma, and is then connected (hooked and fused) to the riser of the segment 3, which is the second one from the segment 1 in the circumferential direction. In the same manner, the conducting wire is wound about groups of thee teeth other than the above described groups, while being connected to segments. As a result, a great number of coils M are wound about the teeth T1 to T16 by duplex wave winding.

Three positive brushes 131a to 131c are arranged at equal angular intervals (120°) in the circumferential direction, and three negative brushes 132a to 132c are arranged at equal angular intervals (120°) in the circumferential direction. As shown in FIG. 19A, the positive brushes 131a to 131c and the negative brushes 132a to 132c are alternately provided at equal angular intervals (60°) in the circumferential direction. As in the first embodiment, the angular width WB of the positive brushes 131a to 131c and the negative brushes 132a to 132c (the angular width at which the brushes slide on the segments 1 to 16) is set to satisfy the following expression, when the angular width of the arrangement pitch of the segments 1 to 16 is represented by WP (WP=360°/the number of segments (sixteen in the present embodiment)), and the angular width of the clearance between each adjacent pair of the segments 1 to 16 is represented by WU.

WB=(1/3)×WP+WU

FIG. 19B is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 16 (that is, by the angular width WP), current pulsation is generated three times, and the number of coils Ma that are short-circuited is changed between two numbers.

Specifically, when the positive brush 131a is at a position where it evenly overlaps with the segments 1 and 2 as shown in FIG. 19A, the short-circuited ones of the coils Ma are, as shown by thick lines in FIG. 19A, the coil Ma wound about the teeth T4 to T6, the coil Ma wound about the teeth T7 to T9, the coil Ma wound about the teeth T12 to T14, and the coil Ma wound about the teeth T15 to T1. In short, four of the coils Ma are short-circuited.

Next, when the armature 103 (the armature core 112 and the commutator 113) is slightly rotated (approximately one-sixth of the angular width WP of the pitch) as shown in FIG. 19B, the short-circuited ones of the coils Ma are, as shown by thick lines in FIG. 19B, the coil Ma wound about the teeth T7 to T9 and the coil Ma wound about the teeth T15 to T1. In short, two of the coils Ma are short-circuited.

Next, when the armature 103 (the armature core 112 and the commutator 113) is slightly rotated (approximately one-sixth of the angular width WP of the pitch) as shown in FIG. 20, the short-circuited ones of the coils Ma are, as shown by thick lines in FIG. 20, the coil Ma wound about the teeth T2 to T4, the coil Ma wound about the teeth T7 to T9, the coil Ma wound about the teeth T10 to T12, and the coil Ma wound about the teeth T15 to T1. In short, four of the coils Ma are short-circuited.

Thereafter, the armature 103 of the direct current motor 101 rotates while repeating the above described operation (see FIGS. 19A to 20).

The present embodiment provides the following advantages.

(11) While the armature 103 rotates by the arrangement pitch of the segments 1 to 16 (that is, by the angular width WP), current pulsation is generated three times, and the number of coils Ma that are short-circuited is repeatedly switched between four and two. That is, the number of coils Ma that are short-circuited is changed between two numbers. Therefore, the present embodiment reduces the torque pulsation to a lower level than the conventional motor, so that vibration and noise are reduced. Also, in the present embodiment, the maximum number of the short-circuited coils Ma is four. Thus, the number of the coils M that are not short-circuited is greater than the first embodiment, in which the maximum number is six. Accordingly, the efficiency is further improved.

(12) Since the number of the teeth T1 to T16 and the number of the segments 1 to 16 are both sixteen, the angular width WB of the positive brushes 131a to 131c and the negative brushes 132a to 132c is greater than that in the second embodiment. Accordingly, the output can be increased by a large current.

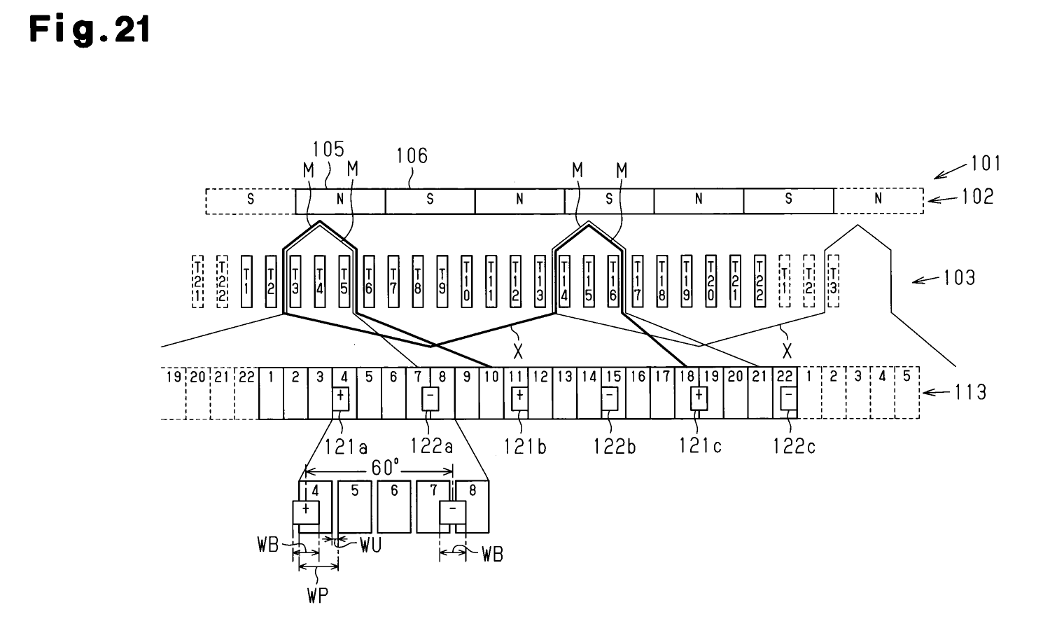

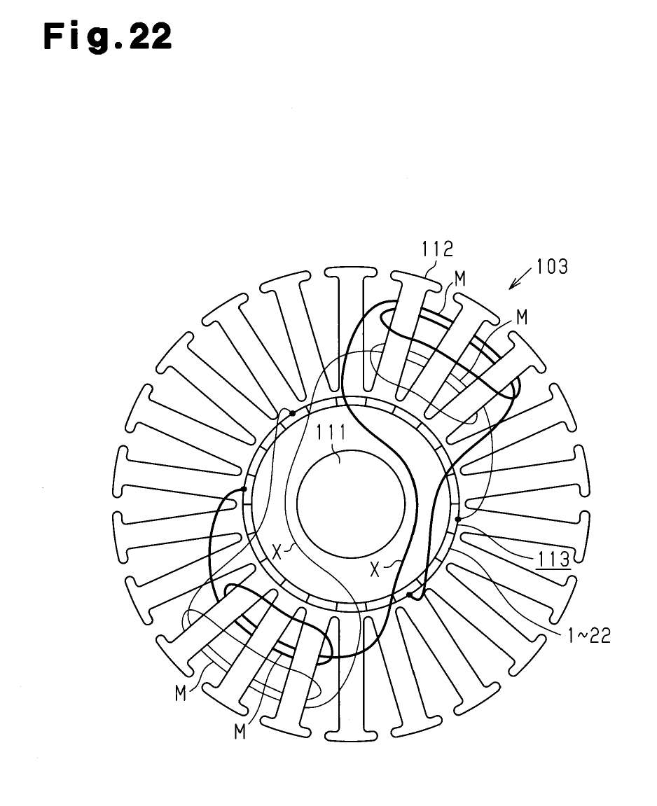

A seventh embodiment of the present invention will now be described with reference to FIGS. 21 and 22. In the seventh embodiment, like or the same reference numerals are given to those components that are like or the same as the corresponding components of the first embodiment, and detailed explanations thereof are partly omitted.

The coils M of the present embodiment have a different configuration from the coils M of the first embodiment, which are wound by duplex wave winding (for example, see FIG. 3). Specifically, as shown in FIGS. 21 and 22, each pair of coils M that are spaced apart by 180° in the circumferential direction are connected to common ones of the segments 1 to 22. The coils M of the present embodiment are connected such that current is supplied thereto at the same timing at which the coils M wound by duplex wave winding receive current. Specifically, in the present embodiment, each pair of coils M that are spaced apart by 180° in the circumferential direction are connected in series to a pair of the segments 1 to 22.

Specifically, in the present embodiment, as shown by thick lines in FIG. 21, a conducting wire is connected (hooked and fused) to the riser of the segment 10 and wound about radially outer parts of a group of three teeth T5 to T3 in a second direction, or in a counterclockwise direction as viewed in FIG. 21, to form a coil M. The conducting wire is extended to a group of the teeth T14 to T16, which is located on the side opposite to the group of the teeth T5 to T3 in the radial direction, without being connected to a riser. A section of the conducting wire that extends from the group of the teeth T5 to T3 to the group of the teeth T14 to T16 through the vicinity of the commutator 113 is expressed as a connecting wire X. Then, to form the next coil M, the conducting wire is wound about radially inner parts of a group of the teeth T14 to T16 in a first direction, or in a clockwise direction as viewed in FIG. 21. Thereafter, the conducting wire is connected (hooked and fused) to the riser of the segment 18. As shown by thin lines in FIG. 21, another conducting wire is connected (hooked and fused) to the riser of the segment 7 and wound about radially inner parts of a group of three teeth T5 to T3 in a second direction, or in a counterclockwise direction as viewed in FIG. 21, to form a coil M. Further, the conducting wire is wound about radially outer parts the teeth T14 to T16 in the first direction (clockwise direction as viewed in FIG. 21), without being connected to a riser. Thereafter, the conducting wire is connected (hooked and fused) to the riser of the segment 21. In FIGS. 21 and 22, only four of the coils M, which have been described so far. Likewise, coils M are wound about the other ones of the teeth T1 to T22.

Three positive brushes 121a to 121c are arranged at equal angular intervals (120°) in the circumferential direction, and three negative brushes 122a to 122c are arranged at equal angular intervals (120°) in the circumferential direction. As shown in FIG. 21, the positive brushes 121a to 121c and the negative brushes 122a to 122c are alternately provided at equal angular intervals (60°) in the circumferential direction. As in the first embodiment, the angular width WB of the positive brushes 121a to 121c and the negative brushes 122a to 122c (the angular width at which the brushes slide on the segments 1 to 22) is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB=(2/3)×WP+WU

FIG. 21 is an enlarged view that schematically shows parts of the angular widths WB, WP, and WU.

In the direct current motor 101 as describe above, while the armature 103 rotates by the amount corresponding to the arrangement pitch of the segments 1 to 22 (that is, by the angular width WP), current pulsation is generated three times, and the number of coils Ma that are short-circuited is changed between two numbers, as in the first embodiment.

The present embodiment provides the following advantages.

(13) While the armature 103 rotates by the arrangement pitch of the segments 1 to 22 (that is, by the angular width WP), current pulsation is generated three times, and the number of coils Ma that are short-circuited is repeatedly switched between six and four. That is, the number of coils Ma that are short-circuited is changed between two numbers. Therefore, the present embodiment reduces the torque pulsation to a lower level than the conventional motor, so that vibration and noise are reduced.

(14) Since the number of the teeth T1 to T22 and the number of the segments 1 to 22 are both twenty-two, the commutator 113 and the armature core 112 of a conventionally manufactured direct current motor having four magnetic poles and twenty-two teeth (four poles and twenty-two slots) can be used. This reduces the manufacturing costs including the costs for manufacturing the facility.

(15) Each pair of coils M that are spaced apart by 180° in the circumferential direction about the rotary shaft 111 are connected to common ones of the segment 1 to 22. Therefore, for example, even if the positions of the positive brushes 121a to 121c and the positions of the negative brushes 122a to 122c (the positions spaced apart at equal angular intervals (60°) in the circumferential direction about the rotary shaft 111) have slight errors, a current is simultaneously supplied to each pair of the coils M that are spaced apart by 180° in the circumferential direction about the rotary shaft 111 in a reliable manner, so that these coils M are reliably short-circuited simultaneously and the current is rectified. That is, the coils M that are wound simply by duplex wave winding are configured such that a current is simultaneously supplied to each pair of the coils M that are spaced apart by 180° in the circumferential direction about the rotary shaft 111, in other words, such that each pair of the coils M that are spaced apart by 180° in the circumferential direction about the rotary shaft 111 are simultaneously short-circuited. However, since each coil M in the pair is connected to different ones of the segments 1 to 22, the timing at which the current is supplied (at which the coils M are short-circuited) is likely to be displaced if there are errors in the positions of the positive brushes 121a to 121c and the positions in the negative brushes 122a to 122c. The present invention allows such displacement to be avoided. This reduces the imbalance of electromagnetic forces, and thus further reduces vibration and noise.

(16) Each pair of coils M that are spaced apart by 180° in the circumferential direction about the rotary shaft 111 are connected in series to a pair of the segments 1 to 22. Thus, when current is supplied to one of the pair of the coils M, the current is reliably supplied to other coil M. Therefore, the same advantage as the above described advantage of item (15) is achieved.

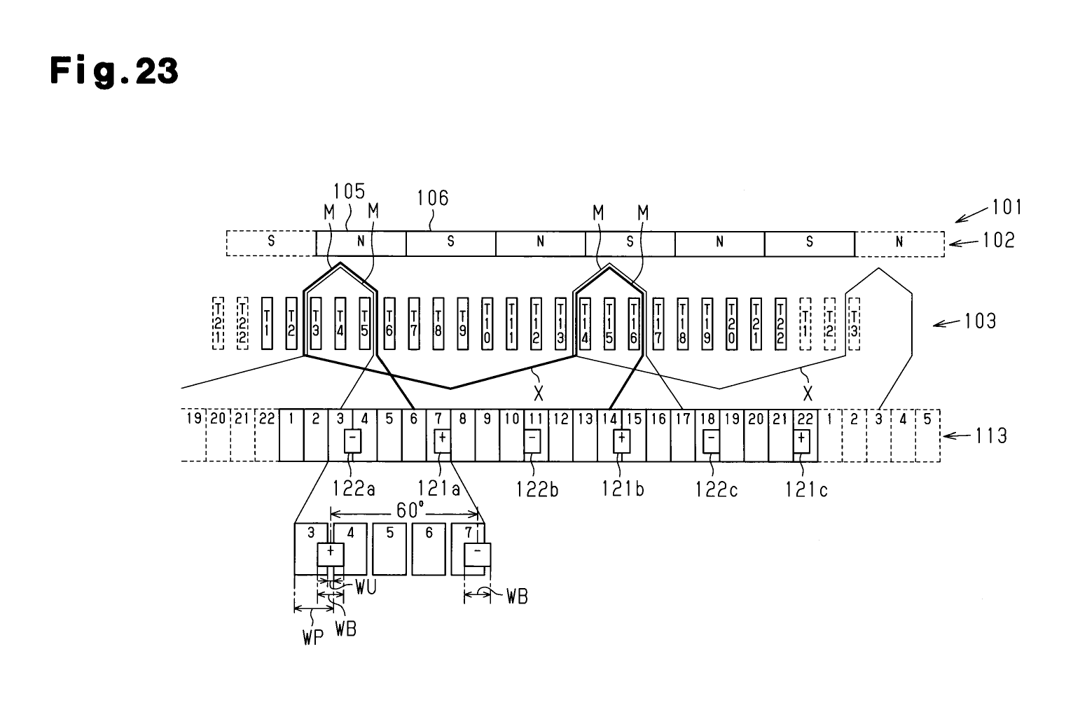

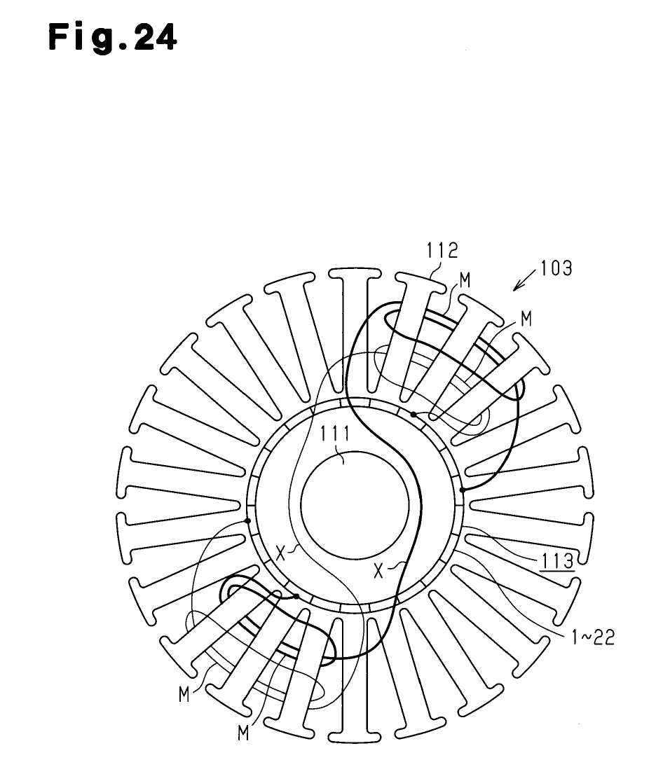

An eighth embodiment of the present invention will now be described with reference to FIGS. 23 and 24. In the eight embodiment, like or the same reference numerals are given to those components that are like or the same as the corresponding components of the first embodiment, and detailed explanations thereof are partly omitted.

The coils M of the present embodiment have a different configuration from the coils M of the first embodiment, which are wound by duplex wave winding (for example, see FIG. 3). Specifically, as shown in FIGS. 23 and 24, each pair of coils M that are spaced apart by 180° in the circumferential direction are connected to common ones of the segments 1 to 22. The coils M of the present embodiment are connected such that current is supplied thereto at the same timing at which the coils M wound by duplex wave winding receive current. Specifically, in the present embodiment, each pair of coils M that are spaced apart by 180° in the circumferential direction are connected in series to a pair of the segments 1 to 22.

Specifically, in the present embodiment, as shown by thick lines in FIG. 23, a conducting wire is connected (hooked and fused) to the riser of the segment 6 and wound about radially outer parts of a group of three teeth T5 to T3 in a second direction, or in a counterclockwise direction as viewed in FIG. 23, to form a coil M. The conducting wire is extended to a group of the teeth T14 to T16, which is located on the side opposite to the group of the teeth T5 to T3 in the radial direction, without being connected to a riser. A section of the conducting wire that extends from the group of the teeth T5 to T3 to the group of the teeth T14 to T16 through the vicinity of the commutator 113 is expressed as a connecting wire X. Then, to form the next coil M, the conducting wire is wound about radially inner parts of a group of the teeth T14 to T16 in a first direction, or in a clockwise direction as viewed in FIG. 23. Thereafter, the conducting wire is connected (hooked and fused) to the riser of the segment 14. As shown by thin lines in FIG. 23, another conducting wire is connected (hooked and fused) to the riser of the segment 3 and wound about radially inner parts of a group of three teeth T5 to T3 in a second direction (a counterclockwise direction as viewed in FIG. 23) to form a coil M. Further, the conducting wire is wound about radially outer parts of the teeth T14 to T16 in the first direction (clockwise direction as viewed in FIG. 23), without being connected to a riser. Thereafter, a second end of the conducting wire is connected (hooked and fused) to the riser of the segment 17. Accordingly, one coil Ma is formed at radially outer parts of the teeth T14 to T16. In FIGS. 23 and 24, only four of the coils Ma, which have been described so far. Likewise, coils Ma are wound about the other ones of the teeth T1 to T22. Therefore, compared to the seventh embodiment, each of the segments 1 to 22 is closer to a coil Ma to which the segment is connected. Specifically, the segments 7, 10, 18, 21 are changed to the segments 3, 6, 14, 17.

Three positive brushes 121a to 121c are arranged at equal angular intervals (120°) in the circumferential direction, and three negative brushes 122a to 122c are arranged at equal angular intervals (120°) in the circumferential direction. As shown in FIG. 23, the positive brushes 121a to 121c and the negative brushes 122a to 122c are alternately provided at equal angular intervals (60°) in the circumferential direction. In the present embodiment, the positions of the positive brushes 121a to 121c and the negative brushes 122a to 122c are changed in accordance with the positions of the ones of the segments 1 to 22 that are connected to the coils Ma, unlike the seventh embodiment. As in the first embodiment, the angular width WB of the positive brushes 121a to 121c and the negative brushes 122a to 122c is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB=(2/3)×WP+WU

FIG. 23 is an enlarged view that schematically shows parts of the angular widths WB, WP, and WU.

In the direct current motor 101 as describe above, while the armature 103 rotates by the amount corresponding to the arrangement pitch of the segments 1 to 22 (that is, by the angular width WP), current pulsation is generated three times, and the number of coils Ma that are short-circuited is changed between two numbers, as in the first embodiment.

The present embodiment provides the following advantages.

(17) While the armature 103 rotates by the arrangement pitch of the segments 1 to 22 (that is, by the angular width WP), current pulsation is generated three times, and the number of coils Ma that are short-circuited is repeatedly switched between six and four. That is, the number of coils Ma that are short-circuited is changed between two numbers. Therefore, the torque pulsation is reduced to a lower level than the conventional motor, so that vibration and noise are reduced.

(18) Since the number of the teeth T1 to T22 and the number of the segments 1 to 22 are both twenty-two, the commutator 113 and the armature core 112 of a conventionally manufactured direct current motor having four magnetic poles and twenty-two teeth (four poles and twenty-two slots) can be used. This reduces the manufacturing costs including the costs for manufacturing the facility.

(19) Coils Ma that are spaced apart by 180° in the circumferential direction about the rotary shaft 111 are connected to common ones of the segment 1 to 22. Therefore, for example, even if the positions of the positive brushes 121a to 121c and the positions of the negative brushes 122a to 122c (the positions spaced apart at equal angular intervals) (60°) in the circumferential direction about the rotary shaft 111) have slight errors, a current is simultaneously supplied to each pair of the coils Ma that are spaced apart by 180° in the circumferential direction about the rotary shaft 111 in a reliable manner, so that these coils Ma are reliably short-circuited simultaneously and the current is rectified. That is, the coils M that are wound simply by duplex wave winding are configured such that a current is simultaneously supplied to each pair of the coils Ma that are spaced apart by 180° in the circumferential direction about the rotary shaft 111, in other words, such that each pair of the coils M that are spaced apart by 180° in the circumferential direction about the rotary shaft 111 are simultaneously short-circuited. However, since each coil M in the pair is connected to different ones of the segments 1 to 22, the timing at which the current is supplied (at which the coils M are short-circuited) is likely to be displaced if there are errors in the positions of the positive brushes 121a to 121c and the positions in the negative brushes 122a to 122c. The present invention allows such displacement to be avoided. This reduces the imbalance of electromagnetic forces, and thus further reduces vibration and noise.

(20) Each pair of coils M that are spaced apart by 180° in the circumferential direction about the rotary shaft 111 are connected in series to a pair of the segments 1 to 22. Thus, when current is supplied to one of the pair of the coils M, the current is reliably supplied to other coil M. Therefore, the same advantage as the above described advantage of item (19) is achieved.

(21) Compared to the seventh embodiment, each of the segments 1 to 22 is closer to a coil M to which the segment is connected. Specifically, the segments 7, 10, 18, 21 are changed to the segments 3, 6, 14, 17, and the positions of the positive brushes 121a to 121c and the negative brushes 122a to 122c are changed in accordance with the changed segments. This shortens the lengths of the conducting wires for routing.

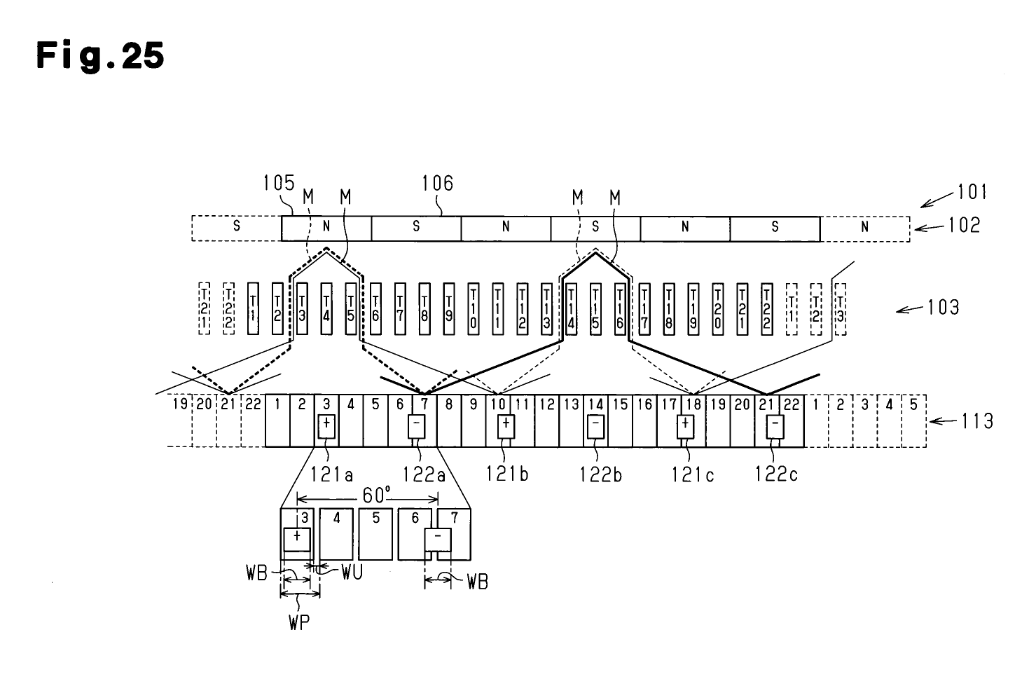

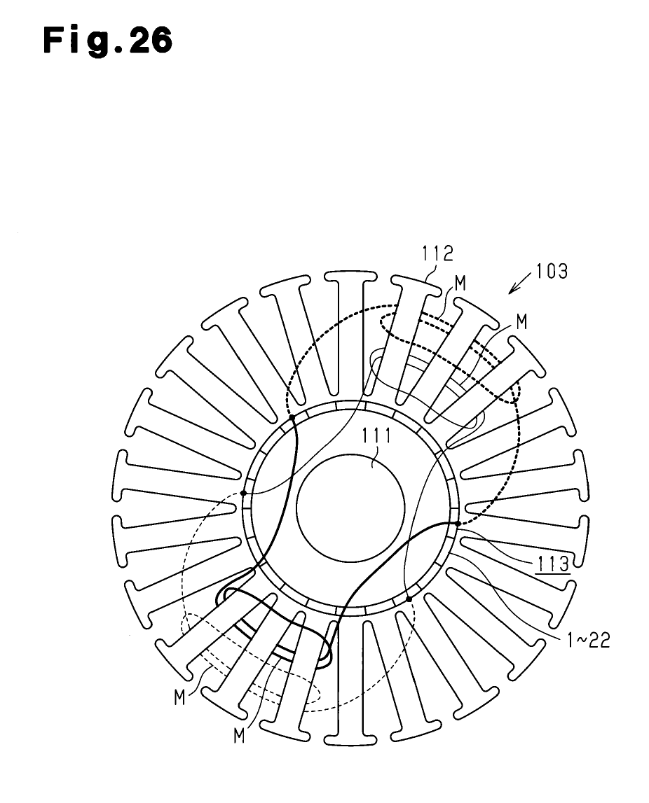

A ninth embodiment of the present invention will now be described with reference to FIGS. 25 and 26. In the ninth embodiment, like or the same reference numerals are given to those components that are like or the same as the corresponding components of the first embodiment, and detailed explanations thereof are partly omitted.

The coils M of the present embodiment have a different configuration from the coils M of the first embodiment, which are wound by duplex wave winding (for example, see FIG. 3). Specifically, as shown in FIGS. 25 and 26, each pair of coils M that are spaced apart by 180° in the circumferential direction are connected to common ones of the segments 1 to 22. The coils M of the present embodiment are connected such that current is supplied thereto at the same timing at which the coils M wound by duplex wave winding receive current. Specifically, in the present embodiment, each pair of coils M that are spaced apart by 180° in the circumferential direction are connected in parallel to a pair of the segments 1 to 22.

Specifically, in the present embodiment, as shown by thick lines in FIG. 25, a conducting wire is connected (hooked and fused) to the riser of the segment 7 and wound about radially inner parts of a group of three teeth T14 to T16 in a first direction, or in a clockwise direction as viewed in FIG. 25, to form a coil M. Thereafter, the conducting wire is connected (hooked and fused) to the riser of the segment 21. Also, as shown by thick lines in FIG. 25, another conducting wire is connected (hooked and fused) to the riser of the segment 21 and wound about radially outer parts of a group of three teeth T3 to T5 (the teeth that are circumferentially spaced apart from the teeth T14 to T16 by 180°) in a first direction, or in a clockwise direction as viewed in FIG. 25, to form a coil M. Thereafter, the conducting wire is connected (hooked and fused) to the riser of the segment 7. Further, as shown by thin broken lines and thin solid lines, two coils M that are connected in parallel to a pair of the segments 10, 18 as in the case described above. In FIGS. 25 and 26, only four of the coils M, which have been described so far. Likewise, coils are wound about the other ones of the teeth T1 to T22.

Three positive brushes 121a to 121c are arranged at equal angular intervals (120°) in the circumferential direction, and three negative brushes 122a to 122c are arranged at equal angular intervals (120°) in the circumferential direction. As shown in FIG. 25, the positive brushes 121a to 121c and the negative brushes 122a to 122c are alternately provided at equal angular intervals (60°) in the circumferential direction. As in the first embodiment, the angular width WB of the positive brushes 121a to 121c and the negative brushes 122a to 122c (the angular width at which the brushes slide on the segments 1 to 22) is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB=(2/3)×WP+WU

FIG. 25 is an enlarged view that schematically shows parts of the angular widths WB, WP, and WU.

In the direct current motor 101 as describe above, while the armature 103 rotates by the amount corresponding to the arrangement pitch of the segments 1 to 22 (that is, by the angular width WP), current pulsation is generated three times, and the number of coils Ma that are short-circuited is changed between two numbers, as in the first embodiment.

The present embodiment provides the following advantages.

(22) While the armature 103 rotates by the arrangement pitch of the segments 1 to 22 (that is, by the angular width WP), current pulsation is generated three times, and the number of coils Ma that are short-circuited is repeatedly switched between six and four. That is, the number of coils Ma that are short-circuited is changed between two numbers. Therefore, the present embodiment reduces the torque pulsation to a lower level than the conventional motor, so that vibration and noise are reduced.

(23) Since the number of the teeth T1 to T22 and the number of the segments 1 to 22 are both twenty-two, the commutator 113 and the armature core 112 of a conventionally manufactured direct current motor having four magnetic poles and twenty-two teeth (four poles and twenty-two slots) can be used. This reduces the manufacturing costs including the costs for manufacturing the facility.

(24) Coils Ma that are spaced apart by 180° in the circumferential direction about the rotary shaft 111 are connected to common ones of the segment 1 to 22. Therefore, for example, even if the positions of the positive brushes 121a to 121c and the positions of the negative brushes 122a to 122c (the positions spaced apart at equal angular intervals) (60°) in the circumferential direction about the rotary shaft 111) have slight errors, a current is simultaneously supplied to each pair of the coils Ma that are spaced apart by 180° in the circumferential direction about the rotary shaft 111 in a reliable manner, so that these coils Ma are reliably short-circuited simultaneously and the current is rectified. That is, the coils M that are wound simply by duplex wave winding are configured such that a current is simultaneously supplied to each pair of the coils Ma that are spaced apart by 180° in the circumferential direction about the rotary shaft 111, in other words, such that each pair of the coils M that are spaced apart by 180° in the circumferential direction about the rotary shaft 111 are simultaneously short-circuited. However, since each coil M in the pair is connected to different ones of the segments 1 to 22, the timing at which the current is supplied (at which the coils M are short-circuited) is likely to be displaced if there are errors in the positions of the positive brushes 121a to 121c and the positions in the negative brushes 122a to 122c. The present invention allows such displacement to be avoided. This reduces the imbalance of electromagnetic forces, and thus further reduces vibration and noise.

(25) Each coil Ma and the corresponding coil Ma are wound about a group of three teeth and another group of three teeth that are located on the opposite side of the rotary shaft 111 from the first group of three teeth, respectively. The coils Ma in each pair are connected in parallel to a pair of the segments 1 to 22. This allows the coils Ma to reliably receive a current simultaneously. Therefore, the same advantage as the above described advantage of item (3) is achieved.

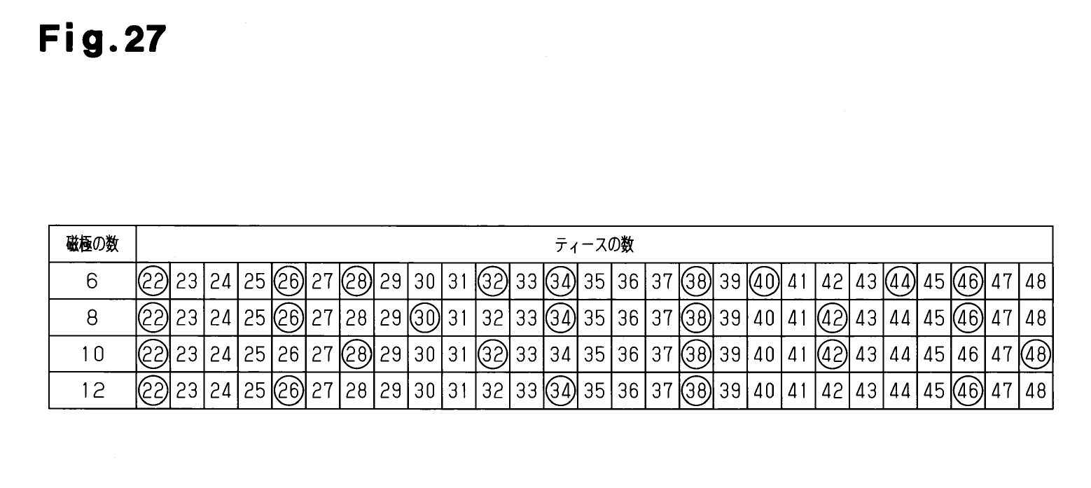

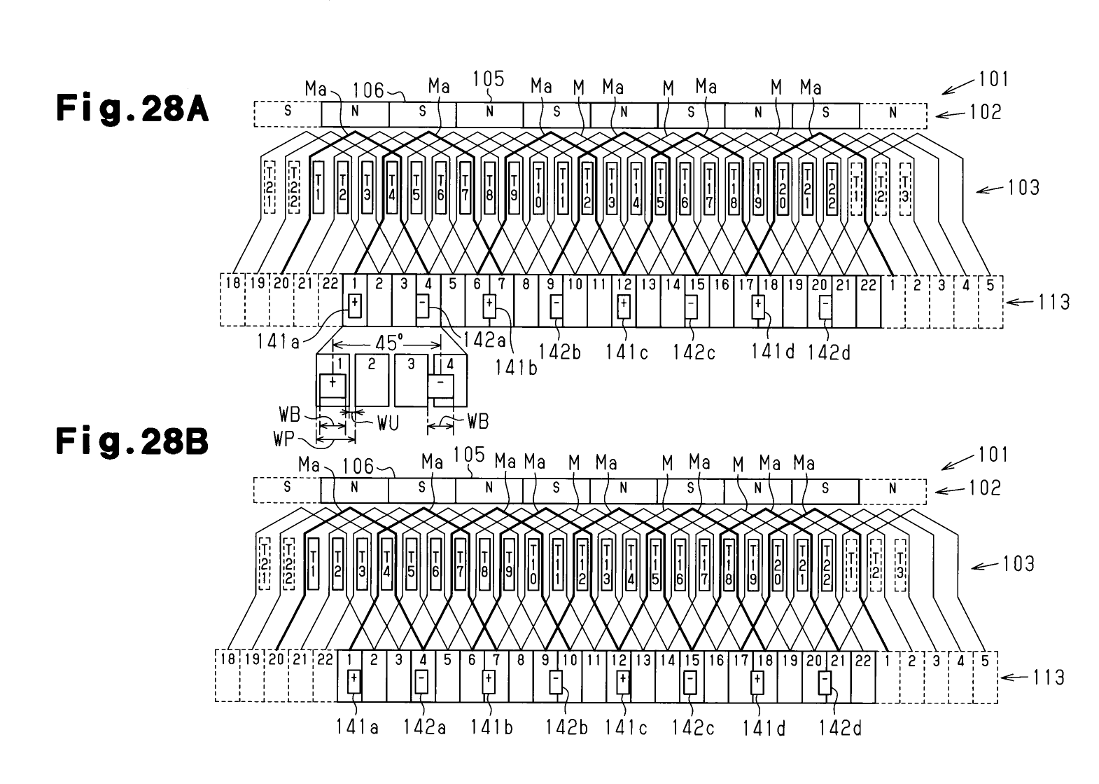

A tenth embodiment of the present invention will now be described with reference to FIGS. 27 and 28. In each of the above described embodiments, the present invention is applied to a direct current motor 101 having sixe magnetic poles (the magnets 105, 106). In the present embodiment, a direct current motor 101 will be described that has magnetic poles (magnets 105, 106), the number of which is represented by P (where P is an even number greater than or equal to six). For example, when the number of the magnetic poles (the magnets 105, 106) is six, eight, ten, or twelve, the number of the circled teeth in FIG. 27 is represented by the expression n×P±2 (where n is a natural number). In the case where the number P of the magnetic poles (the magnets 105, 106) is six, the number of the teeth may be, for example, thirty-two, thirty-four, thirty-eight, forty, forty-four, or forty-six, other than the above described embodiments. Also, in the case where the number P of the magnetic poles (the magnets 105, 106) is eight, the number of the teeth may be, for example, twenty-two, twenty-six, thirty, thirty-four, thirty-eight, forty-two, or forty-six. Also, in the case where the number P of the magnetic poles (the magnets 105, 106) is ten, the number of the teeth may be, for example, twenty-two, twenty-eight, thirty-two, thirty-eight, forty-two, or forty-eight. Also, in the case where the number P of the magnetic poles (the magnets 105, 106) is twelve, the number of the teeth may be, for example, twenty-two, twenty-six, thirty-four, thirty-eight, or forty-six. Even in these cases, the angular width WB may set to any value as long as it satisfies the expression WB≦(4/P)×WP+WU.

Hereinafter, the tenth embodiment will be described with reference to FIG. 28, in which the present invention is applied to a direct current motor 101 having magnets 105, 106, or eight magnetic poles. In the tenth embodiment, like or the same reference numerals are given to those components that are like or the same as the corresponding components of the first embodiment, and detailed explanations thereof are partly omitted.

An armature core 112 has twenty-two (n×P±2 (where n=3)) teeth T1 to T22.

A commutator 113 includes segments 1 to 22, the number of which is equal to the number of the teeth T1 to T22.

Also, in the present embodiment, as shown in FIG. 28A, for example, a conducting wire is connected (hooked and fused) to the riser of the segment 1 and wound about a group of four teeth T4 to T7 in a first direction, or in a clockwise direction as viewed in FIG. 28A, to form a coil M. Thereafter, the conducting wire is connected (hooked and fused) to the riser of the segment 7. After being connected to the riser of the segment 7, the conducting wire is successively wound about four teeth T10 to T13 in the first direction to form the next coil M, and is then connected (hooked and fused) to the riser of the segment 13. After being connected to the riser of the segment 13, the conducting wire is successively wound about four teeth T16 to T19 in the first direction to form the next coil M, and is then connected (hooked and fused) to the riser of the segment 19. After being connected to the riser of the segment 19, the conducting wire is successively wound about four teeth T22 to T3 in the first direction to form the next coil M, and is then connected (hooked and fused) to the riser of the segment 3, which is the second one from the segment 1 in the circumferential direction. In the same manner, the conducting wire is wound about groups of four teeth other than the above described groups, while being connected to segments. As a result, a great number of coils M are wound about the teeth T1 to T22 by duplex wave winding.

Three positive brushes 141a to 141d are arranged at equal angular intervals (90°) in the circumferential direction, and three negative brushes 142a to 142d are arranged at equal angular intervals (90°) in the circumferential direction. As shown in FIG. 28A, the positive brushes 141a to 141d and the negative brushes 142a to 142d are alternately provided at equal angular intervals (45°) in the circumferential direction. That is, there are four positive brushes 141a to 141d and four negative brushes 142a to 142d. The angular width WB of the positive brushes 141a to 141d and the negative brushes 142a to 142d (the angular width at which the brushes slide on the segments 1 to 22) is set to satisfy the following expression, when the angular width of the arrangement pitch of the segments 1 to 22 is represented by WP (WP=360°/the number of segments (twenty-two in the present embodiment)), and the angular width of the clearance between each adjacent pair of the segments 1 to 22 is represented by WU.

WB≦(4/P)×WP+WU, that is, WB≦(1/2)×WP+WU

More specifically, the angular width WB is set to satisfy the following expression.

WB=(1/2)×WP+WU

FIG. 28A is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 22 (that is, by the angular width WP), current pulsation is generated four times (P/2 times), and the number of coils Ma that are short-circuited is changed between two numbers.

Specifically, when the positive brush 141a is substantially at the center in the circumferential direction of the segment 1 as shown in FIG. 28A, the short-circuited ones of the coils Ma are, as shown by thick lines in FIG. 28A, the coil Ma wound about the teeth T4 to T7, the coil Ma wound about the teeth T9 to T12, the coil Ma wound about the teeth T12 to T15, the coil Ma wound about the teeth T15 to T18, the coil Ma wound about the teeth T20 to T1, and the coil Ma wound about the teeth T1 to T4. In short, six of the coils Ma are short-circuited.

Next, when the armature 103 (the armature core 112 and the commutator 113) is slightly rotated as shown in FIG. 28B, the short-circuited ones of the coils Ma are, as shown by thick lines in FIG. 28B, the coil Ma wound about the teeth T4 to T7, the coil Ma wound about the teeth T7 to T10, the coil Ma wound about the teeth T9 to T12, the coil Ma wound about the teeth T12 to T15, the coil Ma wound about the teeth T15 to T18, the coil Ma wound about the teeth T18 to T21, the coil Ma wound about the teeth T20 to T1, and the coil Ma wound about the teeth T1 to T4. In short, eight of the coils Ma are short-circuited.

Thereafter, the armature 103 of the direct current motor 101 rotates while repeating the above described operation.

The present embodiment provides the following advantages.

(26) The angular width WB is set to satisfy the expression WB≦(4/P)×WP+WU. Accordingly, while the armature 103 (the armature core 112 and the commutator 113) rotates by the arrangement pitch of the segments 1 to 22 (that is, by the angular width WP), current pulsation is generated four times (P/2 times), and the number of coils Ma that are short-circuited is repeatedly switched between six and eight. That is, the number of coils Ma that are short-circuited is changed between two numbers. Therefore, the torque pulsation is reduced to a lower level than the conventional motor, so that vibration and noise are reduced. Since the angular width WB satisfies the expression WB=(4/P)×WP+WU, the amplitude of the waveform of the current pulsation is constant. This further reduces vibration and noise.

In the above description, the angular width WB is set to satisfy the expression WB=(4/P)×WP+WU. However, the angular width WB may be any value that satisfies the expression WB≦(4/P)×WP+WU. For example, the angular width WB may be any value that satisfies the expression WB≦(2/P)×WP+WU, that is, WB≦(1/4)×WP+WU. In this case, the number of coils Ma that are short-circuited is repeatedly switched between four (=P−4) and six (=P−2). Since the maximum number of the short-circuited coils Ma is six (=P−2), the number of the coils M that are not short-circuited is greater than the above embodiments, in which the maximum number is eight. Accordingly, the efficiency is further improved. Further, for example, the angular width WB does not need to be set to satisfy the expression WB=(2/P)×WP+WU, that is, the expression WB=(1/4)×WP+WU. In this case, the amplitude of the waveform of the current pulsation is constant. This further reduces vibration and noise.

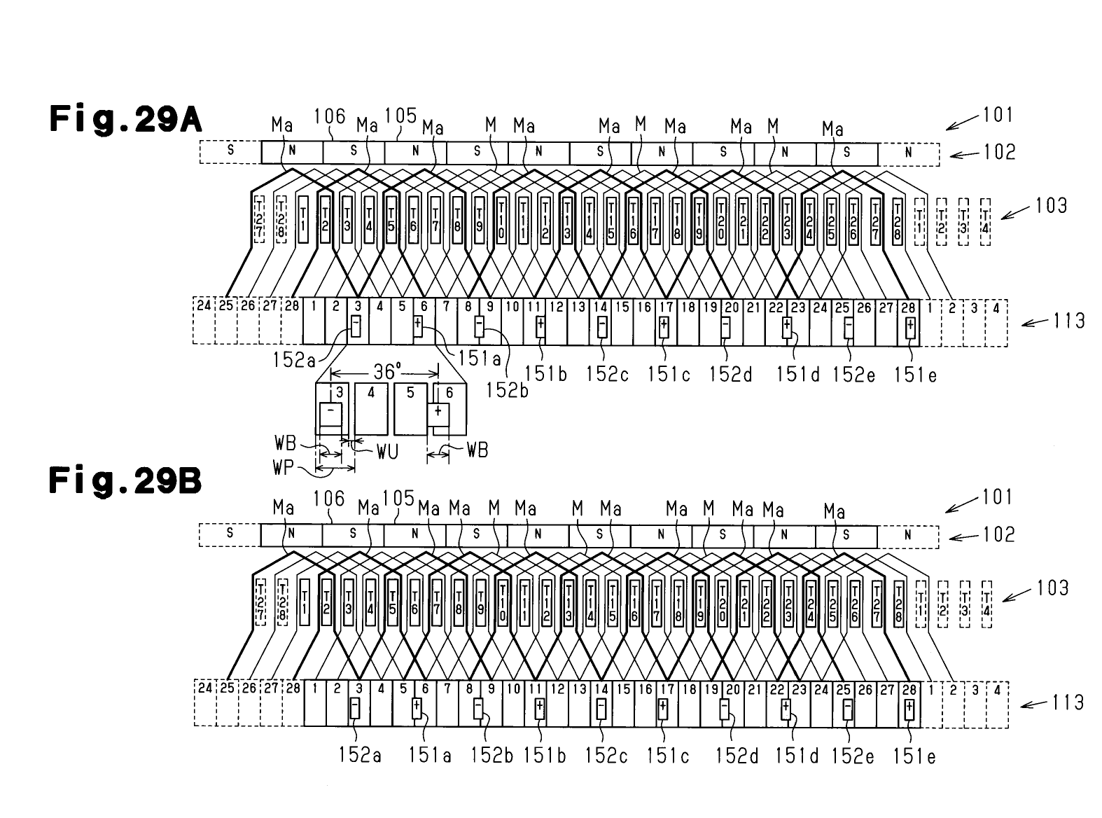

An eleventh embodiment according to the present invention will now be described with reference to FIG. 29. In the eleventh embodiment, like or the same reference numerals are given to those components that are like or the same as the corresponding components of the first embodiment, and detailed explanations thereof are partly omitted.

A stator 102 of the present embodiment has magnets 105, 106, which are magnetic poles the number of which is ten (P).

Also, an armature core 112 has twenty-eight (n×P±2 (where N=3)) teeth T1 to T28.

A commutator 113 includes segments 1 to 28, the number of which is equal to the number of the teeth T1 to T28.

As shown in FIG. 29A, for example, a conducting wire is connected (hooked and fused) to the riser of the segment 1 and wound about a group of four teeth T3 to T6 in a first direction, or in a clockwise direction as viewed in FIG. 29A. Thereafter, the conducting wire is connected (hooked and fused) to the riser of the segment 7. After being connected to the riser of the segment 7, the conducting wire is successively wound about four teeth T9 to T12 in the first direction to form the next coil M, and is then connected (hooked and fused) to the riser of the segment 13. After being connected to the riser of the segment 13, the conducting wire is successively wound about four teeth T15 to T18 in the first direction to form the next coil M, and is then connected (hooked and fused) to the riser of the segment 19. After being connected to the riser of the segment 19, the conducting wire is successively wound about four teeth T21 to T24 in the first direction to form the next coil Ma, and is then connected (hooked and fused) to the riser of the segment 25. After being connected to the riser of the segment 25, the conducting wire is successively wound about four teeth T27 to T2 in the first direction to form the next coil M, and is then connected (hooked and fused) to the riser of the segment 3, which is the second one from the segment 1 in the circumferential direction. In the same manner, the conducting wire is wound about groups of four teeth other than the above described groups, while being connected to segments. A great number of coils M are wound about the teeth T1 to T28 by duplex wave winding.

Also, five positive brushes 151a to 151e are arranged at equal angular intervals (72°) in the circumferential direction, and five negative brushes 152a to 152e are arranged at equal angular intervals (72°) in the circumferential direction. As shown in FIG. 29A, the positive brushes 151a to 151e and the negative brushes 152a to 152e are alternately provided at equal angular intervals (36°) in the circumferential direction. That is, there are five (P/2) positive brushes 151a to 151e and five (P/2) negative brushes 152a to 152e. The angular width WB of the positive brushes 151a to 151e and the negative brushes 152a to 152e (the angular width at which the brushes slide on the segments 1 to 28) is set to satisfy the following expression, when the angular width of the arrangement pitch of the segments 1 to 28 is represented by WP (WP=360°/the number of segments (twenty-eight in the present embodiment)), and the angular width of the clearance between each adjacent pair of the segments 1 to 28 is represented by WU.

WB≦(4/P)×WP+WU, that is, WB≦(2/5)×WP+WU

More specifically, the angular width WB is set to satisfy the following expression.

WB=(2/5)×WP+WU

FIG. 29A is an enlarged view that schematically shows parts of the angular widths WB, WP, and WU.

In the direct current motor 101 as describe above, while the armature 103 (the armature core 112 and the commutator 113) rotates by the amount corresponding to the arrangement pitch of the segments 1 to 28 (that is, by the angular width WP), current pulsation is generated P/2 times, or five times, and the number of coils Ma that are short-circuited is changed between two numbers.

Specifically, when the negative brush 152b is at a position where it substantially evenly overlaps with the segments 8 and 9 as shown in FIG. 29A, the short-circuited ones of the coils Ma are, as shown by thick lines in FIG. 29A, the coil Ma wound about the teeth T2 to T5, the coil Ma wound about the teeth T5 to T8, the coil Ma wound about the teeth T10 to T13, the coil Ma wound about the teeth T13 to T16, the coil Ma wound about the teeth T16 to T19, the coil Ma wound about the teeth T19 to T22, the coil Ma wound about the teeth T24 to T27, and the coil Ma wound about the teeth T27 to T2. In short, eight of the coils Ma are short-circuited.

Next, when the armature 103 (the armature core 112 and the commutator 113) is slightly rotated as shown in FIG. 29B, the short-circuited ones of the coils Ma are, as shown by thick lines in FIG. 29B, the coil Ma wound about the teeth T2 to T5, the coil Ma wound about the teeth T5 to T8, the coil Ma wound about the teeth T7 to T10, the coil Ma wound about the teeth T10 to T13, the coil Ma wound about the teeth T13 to T16, the coil Ma wound about the teeth T16 to T19, the coil Ma wound about the teeth T19 to T22, the coil Ma wound about the teeth T21 to T24, the coil Ma wound about the teeth T24 to T27, and the coil Ma wound about the teeth T27 to T2. In short, ten of the coils Ma are short-circuited.

Thereafter, the armature 103 of the direct current motor 101 rotates while repeating the above described operation.

The present embodiment provides the following advantages.

(27) The angular width WB is set to satisfy the expression WB≦(4/P)×WP+WU. Accordingly, while the armature 103 rotates by the arrangement pitch of the segments 1 to 28 (that is, by the angular width WP), current pulsation is generated five times (P/2 times), and the number of coils Ma that are short-circuited is repeatedly switched between eight and ten. That is, the number of coils Ma that are short-circuited is changed between two numbers. Therefore, the pulsation is reduced to a lower level than the conventional motor, so that vibration and noise are reduced. Since the angular width WB satisfies the expression WB=(4/P)×WP+WU, the amplitude of the waveform of the current pulsation is constant. This further reduces vibration and noise.

In the above description, the angular width WB is set to satisfy the expression WB=(4/P)×WP+WU. However, the angular width WB may be any value that satisfies the expression WB≦(4/P)×WP+WU. For example, the angular width WB may be any value that satisfies the expression WB≦(2/P)×WP+WU, that is, WB≦(1/5)×WP+WU. In this case, the number of coils Ma that are short-circuited is repeatedly switched between six (=P−4) and eight (=P−2). Since the maximum number of the short-circuited coils Ma is eight (=P−2), the number of the coils M that are not short-circuited is greater than that in the eleventh embodiment, in which the maximum number is ten. Accordingly, the efficiency is further improved. Further, for example, the angular width WB does not need to be set to satisfy the expression WB=(2/P)×WP+WU, that is, the expression WB≦(1/5)×WP+WU. In this case, the amplitude of the waveform of the current pulsation is constant. This further reduces vibration and noise.

The above described embodiments may be modified as follows.

The configuration of the coils M are not particularly limited to those presented in the above embodiments, as long as the coils M are wound about teeth by duplex wave winding or as long as the coils M are wound about teeth so as to receive current at the same timing at which the coils wound by duplex wave winding receive current. For example, the connecting wires X (see FIGS. 21 and 23) employed in the seventh and eighth embodiments may be arranged at the side opposite to the commutator 113 in the axial direction of the rotary shaft 111.

In each of the above embodiments, the present invention is applied to the direct current motor 101 for an electric power steering system. However, the present invention may be applied to direct current motors used in other types of apparatuses.

What is claimed is:

1. A direct current motor comprising:
a yoke and a stator, the stator having magnetic poles arranged along the circumferential direction of the yoke, the number of the magnetic poles being represented by P (where P is an even number greater than or equal to six);
an armature core rotatable relative to the stator, the armature core having teeth arranged along the circumferential direction, the number of the teeth being represented by an expression n×P±2 (where n is a natural number);
a commutator that is rotatable integrally with the armature core, the commutator having segments the number of which is equal to the number of the teeth;
coils that are wound about the teeth by duplex wave winding or coils that are wound about the teeth such that current is supplied to the coils at the same timing as the timing at which current is supplied to the coils that are wound by duplex wave winding; and
positive brushes and negative brushes that are held by the stator, the brushes being pressed against the segments,
wherein the number of the positive brushes and the number of the negative brushes are both P/2, the positive brushes and the negative brushes being alternately arranged at equal angular intervals, and each of the positive brushes and the negative brushes having an angular width WB at which it slides on the segments, and
wherein, when the angular width of the arrangement pitch of the segments is represented by WP (WP=360°/the number of the segments), and the angular width of the clearance between each pair of circumferentially adjacent segments is represented by WU, the angular width WB is set to satisfy the following expression.
WB≦(4/P)×WP+WU

2. The direct current motor according to claim 1, wherein the angular width WB is set to satisfy the following expression.
WB=(4/P)×WP+WU

3. A direct current motor comprising:
a yoke and a stator, the stator having magnetic poles arranged along the circumferential direction of the yoke, the number of the magnetic poles being represented by P (where P is an even number greater than or equal to six);
an armature core rotatable relative to the stator, the armature core having teeth arranged along the circumferential direction, the number of the teeth being represented by an expression n×P±2 (where n is a natural number);
a commutator that is rotatable integrally with the armature core, the commutator having segments the number of which is equal to the number of the teeth;
coils that are wound about the teeth by duplex wave winding or coils that are wound about the teeth such that current is supplied to the coils at the same timing as the timing at which current is supplied to the coils that are wound by duplex wave winding; and
positive brushes and negative brushes that are held by the stator, the brushes being pressed against the segments,
wherein the number of the positive brushes and the number of the negative brushes are both P/2, the positive brushes and the negative brushes being alternately arranged at equal angular intervals, and each of the positive brushes and the negative brushes having an angular width WB at which it slides on the segments, and
wherein, when the angular width of the arrangement pitch of the segments is represented by WP (WP=360°/the number of the segments), and the angular width of the clearance between each pair of circumferentially adjacent segments is represented by WU, the angular width WB is set to satisfy the following expression.
WB≦(2/P)×WP+WU

4. The direct current motor according to claim 3, wherein the angular width WB is set to satisfy the following expression.
WB=(2/P)×WP+WU

5. A direct current motor comprising:
a yoke and a stator, the stator having six magnetic poles arranged along the circumferential direction of the yoke;
an armature core rotatable relative to the stator, the armature core having teeth arranged along the circumferential direction, the number of the teeth being represented by an expression 3×N±1 (where N is an odd number greater than or equal to three);
a commutator that is rotatable integrally with the armature core, the commutator having segments the number of which is equal to the number of the teeth;
coils that are wound about the teeth by duplex wave winding or coils that are wound about the teeth such that current is supplied to the coils at the same timing as the timing at which current is supplied to the coils that are wound by duplex wave winding; and
positive brushes and negative brushes that are held by the stator, the brushes being pressed against the segments,
wherein the number of the positive brushes and the number of the negative brushes are both three, the positive brushes and the negative brushes being arranged at equal angular intervals, and each of the positive brushes and the negative brushes having an angular width WB at which it slides on the segments, and
wherein, when the angular width of the arrangement pitch of the segments is represented by WP (WP=360°/the number of the segments), and the angular width of the clearance between each pair of circumferentially adjacent segments is represented by WU, the angular width WB is set to satisfy the following expression.
WB=(2/3)×WP+WU

6. A direct current motor comprising:
a yoke and a stator, the stator having six magnetic poles arranged along the circumferential direction of the yoke;
an armature core rotatable relative to the stator, the armature core having teeth arranged along the circumferential direction, the number of the teeth being represented by an expression 3×N±1 (where N is an odd number greater than or equal to three);
a commutator that is rotatable integrally with the armature core, the commutator having segments the number of which is equal to the number of the teeth;
coils that are wound about the teeth by duplex wave winding or coils that are wound about the teeth such that current is supplied to the coils at the same timing as the timing at which current is supplied to the coils that are wound by duplex wave winding; and
positive brushes and negative brushes that are held by the stator, the brushes being pressed against the segments,
wherein the number of the positive brushes and the number of the negative brushes are both three, the positive brushes and the negative brushes being arranged at equal angular intervals, and each of the positive brushes and the negative brushes having an angular width WB at which it slides on the segments, and
wherein, when the angular width of the arrangement pitch of the segments is represented by WP (WP=360°/the number of the segments), and the angular width of the clearance between each pair of circumferentially adjacent segments is represented by WU, the angular width WB is set to satisfy the following expression.
WB=(1/3)×WP+WU

7. The direct current motor according to claim 5, wherein the number of the teeth and the number of the segments are both twenty-two.

8. The direct current motor according to claim 5, wherein the number of the teeth and the number of the segments are both less than or equal to twenty.

9. The direct current motor according to claim 5, wherein the number of the teeth and the number of the segments are both greater than or equal to twenty-six.

10. The direct current motor according to claim 1, wherein the coils are wound about the teeth such that each pair of coils that are spaced apart by 180° are connected to a pair of the segments.

11. The direct current motor according to claim 10, wherein each pair of coils that are spaced apart by 180° are connected in series to a pair of the segments.

12. The direct current motor according to claim 10, wherein each pair of coils that are spaced apart by 180° are connected in parallel to a pair of the segments.

13. The direct current motor according to claim 3, wherein the coils are wound about the teeth such that each pair of coils that are spaced apart by 180° are connected to a pair of the segments.

14. The direct current motor according to claim 13, wherein each pair of coils that are spaced apart by 180° are connected in series to a pair of the segments.

15. The direct current motor according to claim 13, wherein each pair of coils that are spaced apart by 180° are connected in parallel to a pair of the segments.

16. The direct current motor according to claim 5, wherein the coils are wound about the teeth such that each pair of coils that are spaced apart by 180° are connected to a pair of the segments.

17. The direct current motor according to claim 16, wherein each pair of coils that are spaced apart by 180° are connected in series to a pair of the segments.

18. The direct current motor according to claim 16, wherein each pair of coils that are spaced apart by 180° are connected in parallel to a pair of the segments.

19. The direct current motor according to claim 6, wherein the coils are wound about the teeth such that each pair of coils that are spaced apart by 180° are connected to a pair of the segments.

20. The direct current motor according to claim 19, wherein each pair of coils that are spaced apart by 180° are connected in series to a pair of the segments.

21. The direct current motor according to claim 19, wherein each pair of coils that are spaced apart by 180° are connected in parallel to a pair of the segments.
